(19) United States
(12) Patent Application Publication
(10) Pub. No.: US 2025/0069563 A1
(43) Pub. Date: Feb. 27, 2025

(54) DISPLAY DEVICE AND DRIVING METHOD OF DISPLAY DEVICE

(71) Applicant: Sharp Display Technology Corporation, Kameyama City (JP)

(72) Inventor: Fumikazu SHIMOSHIKIRYOH, Kameyama City (JP)

(21) Appl. No.: 18/779,759

(22) Filed: Jul. 22, 2024

(30) Foreign Application Priority Data
Aug. 22, 2023 (JP) 2023-134672

(51) Int. Cl. G09G 3/36

(52) U.S. Cl. CPC G09G 3/3666; G09G 3/3614; G09G 3/3677; G09G 3/3688; G09G 2310/0283; G09G 2330/021; G09G 2380/10

(57) ABSTRACT

A display device includes a substrate including a display region including a plurality of divided regions divided into three or more and disposed in a first direction on a main surface, a scanning line extending in a first direction, a data line extending in a second direction, a plurality of pixels, and a scanning line connection wiring line extending in the second direction, which are disposed in each of the plurality of divided regions, a plurality of data line drive circuits respectively connected to the data lines in each of the plurality of divided regions, and a plurality of scanning line drive circuits corresponding to each of the plurality of divided regions. The scanning line drive circuits and the data line drive circuits are arrayed in the first direction outside the display region, each of the plurality of scanning line connection wiring lines electrically connects the scanning line drive circuit to the scanning line, and the plurality of scanning line drive circuits and the plurality of data line drive circuits display an image at a frame frequency different from each other in at least a pair of divided regions adjacent to each other among the plurality of divided regions.

### CROSS-REFERENCE TO RELATED APPLICATIONS

This application claims the benefit of priority to Japanese Patent Application Number 2023-134672 filed on Aug. 22, 2023. The entire contents of the above-identified application are hereby incorporated by reference.

### BACKGROUND

### Technical Field

The disclosure relates to a display device and a driving method of a display device.

Display devices, such as a liquid crystal display device and an organic electroluminescence (EL) display device, are widely used in various fields. For example, in the field of vehicles, information such as a speed or a rotation speed is displayed on a display device instead of a typically used mechanical speedometer or tachometer.

For example, JP 2022-072294 A discloses a vehicle including a display device located in front of a driver's seat for displaying the speed, the rotation speed, and the like, and a display device located on a side closer to a passenger seat for displaying map information, a movie, and the like.

### SUMMARY

As the number of display devices mounted on a vehicle increases, an increase in power consumption by the display devices becomes a problem. It is an object of the disclosure to provide a display device including a plurality of display regions and having reduced power consumption and a driving method of the display device.

A display device and a driving method of a display device according to an embodiment of the disclosure includes a substrate including a main surface including a display region and a non-display region located around the display region, the display region including a plurality of divided regions divided into three or more and disposed adjacent to each other along a first direction, a plurality of scanning lines disposed in each of the plurality of divided regions, the plurality of scanning lines extending in the first direction, and being arrayed in a second direction intersecting the first direction, a plurality of data lines disposed in each of the plurality of divided regions, the plurality of data lines extending in the second direction, and being arrayed in the first direction, a plurality of pixels disposed in each of the plurality of divided regions, each of the plurality of pixels being disposed in a region surrounded by a pair of data lines of the plurality of data lines and a pair of scanning lines of the plurality of scanning lines, a plurality of scanning line connection wiring lines disposed in each of the plurality of divided regions, the plurality of scanning line connection wiring lines extending in the second direction, and being arrayed in the first direction, a plurality of data line drive circuits connected to the plurality of data lines, respectively, in each of the plurality of divided regions, a plurality of scanning line drive circuits corresponding to each of the plurality of divided regions, a control device, and a plurality of start signal wiring lines independently connecting the scanning line drive circuits corresponding to each divided region and the control device to each other, in which the plurality of scanning line drive circuits and the plurality of data line drive circuits are arrayed in the first direction outside the display region, each of the plurality of scanning line connection wiring lines electrically connects each of the plurality of scanning line drive circuits to one of the plurality of scanning lines, and the control device independently outputs a start signal to each of the plurality of start signal wiring lines connected to the plurality of scanning line drive circuits in each of the plurality of divided regions, and thus the plurality of scanning line drive circuits and the plurality of data line drive circuits display images at frame frequencies different from each other in at least a pair of divided regions adjacent to each other among the plurality of divided regions.

According to an embodiment of the disclosure, a display device including a plurality of display regions and having reduced power consumption and a driving method of the display device are provided.

### BRIEF DESCRIPTION OF DRAWINGS

The disclosure will be described with reference to the accompanying drawings, wherein like numbers reference like elements.

FIG. 1 is a schematic view illustrating a dashboard of a vehicle on which a display device of a first embodiment is mounted.

FIG. 2A is a schematic cross-sectional view illustrating a configuration of the display device.

FIG. 2B is a schematic cross-sectional view illustrating another configuration of the display device.

FIG. 3 is a plan view of a substrate.

FIG. 4A is a schematic plan view of an active matrix substrate.

FIG. 4B is a schematic plan view of another configuration example of the active matrix substrate.

FIG. 5 is a circuit diagram illustrating a configuration example of pixels.

FIG. 6 illustrates an arrangement of scanning lines, scanning line connection wiring lines, and connection points CP in each divided region.

(a) to (c) and (d) to (f) of FIG. 7 are schematic diagrams respectively illustrating an equivalent circuit diagram of luminance of a pixel in the vicinity of a boundary line between a first divided region and a second divided region, an applied scanning signal, a parasitic capacitance, and a parasitic resistance.

(a) to (c) and (d) to (f) of FIG. 8 are schematic diagrams respectively illustrating an equivalent circuit diagram of luminance of a pixel in the vicinity of a boundary line between a second divided region and a third divided region, an applied scanning signal, a parasitic capacitance, and a parasitic resistance.

FIG. 9 illustrates another arrangement example of the scanning lines, the scanning line connection wiring lines, and the connection points CP.

(a) to (c) and (d) to (f) of FIG. 10 are schematic diagrams respectively illustrating an equivalent circuit diagram of luminance of a pixel in the vicinity of a boundary line between a first divided region and a second divided region, an applied scanning signal, a parasitic capacitance, and a parasitic resistance in the arrangement example illustrated in FIG. 9.

FIG. 11 illustrates another arrangement example of the scanning lines, the scanning line connection wiring lines, and the connection points CP.

(a) to (c) and (d) to (f) of FIG. 12 are schematic diagrams respectively illustrating an equivalent circuit diagram of luminance of a pixel in the vicinity of a boundary line between a first divided region and a second divided region, an applied scanning signal, a parasitic capacitance, and a parasitic resistance in the arrangement example illustrated in FIG. 11.

FIG. 13A is an enlarged plan view illustrating a part of the active matrix substrate.

FIG. 13B is an enlarged plan view illustrating a part of another configuration example of the active matrix substrate.

FIG. 14 is a view for explaining overlapping of scanning lines between divided regions adjacent to each other.

FIG. 15 illustrates an example of a cross-sectional structure of a liquid crystal display device taken along line A-A in FIG. 13.

FIG. 16 is a schematic enlarged plan view of the active matrix substrate further including dummy scanning line connection wiring lines.

FIG. 17 is a plan view illustrating an arrangement example of a scanning line drive circuits.

FIG. 18 is a plan view illustrating another arrangement example of the scanning line drive circuits.

FIG. 19 shows timings to scan the scanning lines in a case in which independent images are displayed in three divided regions, respectively, according to a second embodiment.

FIG. 20 shows a scanning timing and timings of a clock signal and a data signal of the second divided region.

FIG. 21 shows a timing to scan the scanning lines in a case in which independent images are displayed in the divided regions, respectively, according to a third embodiment.

FIG. 22 shows timings to scan the scanning lines in three divided regions according to the third embodiment.

FIG. 23 shows timings to scan the scanning lines according to another example of a driving method.

FIG. 24 shows timings to scan the scanning lines according to another example of the driving method.

FIG. 25 is a block diagram collectively illustrating control signals for driving a pixel.

### DESCRIPTION OF EMBODIMENTS

When there are a plurality of display devices mounted on a vehicle, if the display devices can be collectively disposed at one place so that the display regions are connected to each other, then it is considered that an excellent design can be provided, for example, displaying an integrated image in the plurality of display regions as necessary. For example, when, as disclosed in JP 2022-072294 A, a display device for displaying a speed, a rotation speed, and the like is integrated with a display device extending from a driver's seat to a side closer to a passenger seat and displaying map information, a movie, and the like, an excellent interior design can be provided and an excellent display effect can be obtained.

On the other hand, when the number of display regions of the display device increases and the area of the entire display region increases, power consumption may also increase. In a vehicle such as a hybrid vehicle or an electric vehicle using a motor as a driving source, it is preferable that power consumption of the display device be low so as to extend a cruising distance as much as possible. The disclosure has been made in light of such a problem and conceives a novel display device capable of suppressing power consumption and a driving method of the display device.

### First Embodiment

The present embodiment will be described below with reference to the drawings. The disclosure is not limited to the following embodiments, and appropriate design changes can be made within a scope that satisfies the configuration of the disclosure. Further, in the description below, the same reference signs may be used in common among the different drawings for the same portions or portions having the same or similar functions, and descriptions of repetitions thereof may be omitted. Further, the configurations described in the embodiments and the modified examples may be combined or modified as appropriate within a range that does not depart from the gist of the disclosure. For ease of explanation, in the drawings referenced below, configurations may be simplified or schematically illustrated, or a portion of the components may be omitted. Further, dimensional ratios between components illustrated in the drawings are not necessarily indicative of actual dimensional ratios.

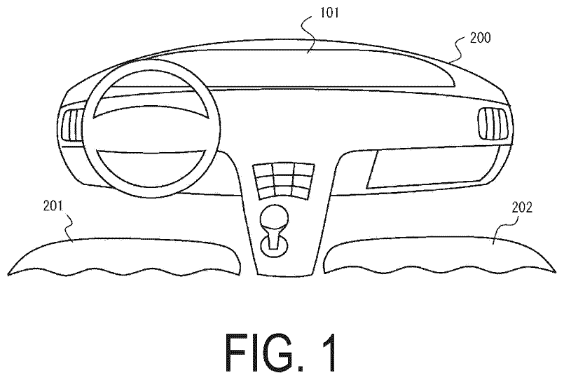

FIG. 1 is a schematic view illustrating a dashboard 200 of a vehicle on which a display device 101 of the present embodiment is mounted. The dashboard 200 is located at the front of the interior of the vehicle. The display device 101 is disposed in an upper portion of the dashboard 200 from a driver's seat 201 to a passenger seat 202. That is, the display device 101 is located in front of the driver's seat 201 and the passenger seat 202 and is an integrated device.

The display device 101 may be any of various flat displays. For example, the display device 101 may be a liquid crystal display device, an organic EL display device, an LED display device, electronic paper, or the like. In the present embodiment, the display device 101 is the liquid crystal display device.

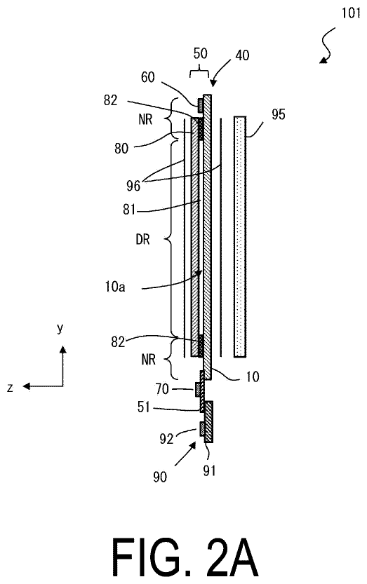

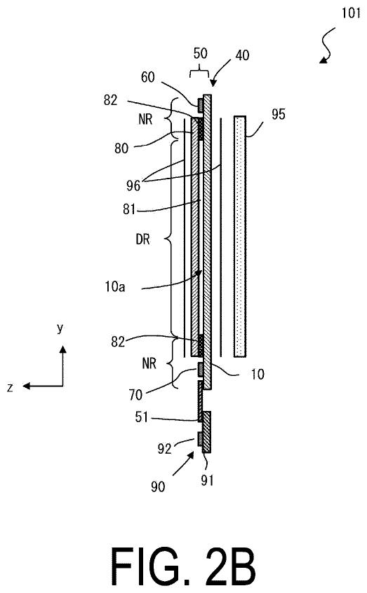

FIG. 2A is a schematic cross-sectional view illustrating a configuration in a case in which the display device 101 is the liquid crystal display device. The display device 101 includes a liquid crystal panel 50 and a control device 90. The liquid crystal panel 50 includes an active matrix substrate 40, a counter substrate 80, and a liquid crystal layer 81.

The active matrix substrate 40 includes a substrate 10 with a main surface 10a. As described in detail below, the main surface 10a includes a display region DR, and a non-display region NR located around the display region DR so as to surround the display region DR. The display region DR is a region that contributes to image display, and the non-display region is a region that does not display an image.

As described in detail below, the active matrix substrate 40 includes a plurality of scanning lines, a plurality of data lines, and a plurality of pixels. Each pixel is connected to one of the plurality of scanning lines and one of the plurality of data lines.

The active matrix substrate 40 and the counter substrate 80 are bonded to each other at a predetermined distance by a seal 82 disposed on the non-display region NR, and the liquid crystal layer 81 is disposed in a region surrounded by the seal 82 and between the active matrix substrate 40 and the counter substrate 80. In the present embodiment, a color filter is provided on a surface of the counter substrate 30 on a side closer to the liquid crystal layer 81. However, the color filter may be provided on the active matrix substrate 40.

The liquid crystal panel 50 further includes a plurality of scanning line drive circuits 60 and a plurality of data line drive circuits 70. The scanning line drive circuits 60 and the data line drive circuits 70 are disposed in regions other than the display region DR of the substrate 10 and drive the scanning lines and the data lines, respectively. In the present embodiment, the scanning line drive circuits 60 are disposed in the non-display region NR. On the other hand, the data line drive circuits 70 are disposed on a flexible substrate 51. As illustrated in FIG. 2B, the plurality of data line drive circuits 70 may be mounted in the non-display region NR of the substrate 10.

The control device 90 includes a substrate 91 and a timing controller 92 mounted on the substrate 91. The control device 90 is connected to the active matrix substrate 40 by the flexible substrate 51. The timing controller 92 receives a video signal from an external host computer and generates a start signal and an image signal. The generated start signal and image signal are output to the scanning line drive circuit 60 and the data line drive circuit 70, respectively.

The display device 101 further includes a pair of polarizers 96 and a backlight 95. The pair of polarizers 96 are located so as to sandwich the active matrix substrate 40 and the counter substrate 80. The backlight 95 is disposed so as to face one of the pair of polarizers 96.

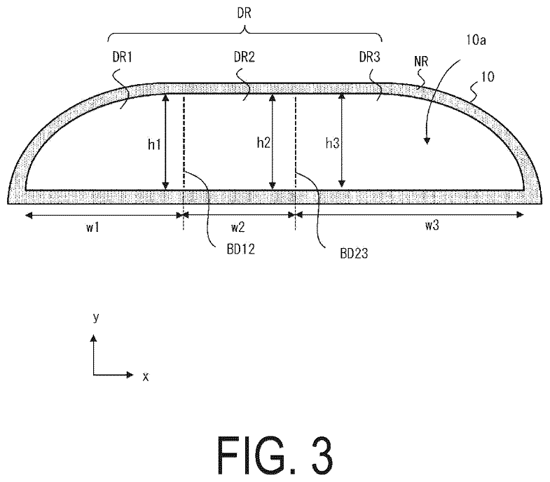

FIG. 3 is a plan view of the substrate 10. The substrate 10 has a longitudinal direction in an x-axis direction (first direction) which is a lateral direction rather than a y-axis direction (second direction) which is a vertical direction. The shape of the substrate 10 is not particularly limited as long as the first direction is the longitudinal direction, and may be, for example, a rectangle, an ellipse, or an oval. In the present embodiment, the substrate 10 has a shape obtained by rounding two upper corners arranged in the x-axis direction in a rectangle whose x-axis direction is the longitudinal direction.

The main surface 10a includes the display region DR and non-display region NR as described above. In the present embodiment, the display region DR has a shape substantially similar to the outer shape of the substrate 10, that is, a shape obtained by rounding two upper corners arranged in the x-axis direction in a rectangle whose x-axis direction is the longitudinal direction. The non-display region NR is located around the display region DR. In the present embodiment, the non-display region NR surrounds the display region DR.

The display region DR includes three or more divided regions disposed adjacent to each other along the x-axis direction. In the present embodiment, the display region DR includes a first divided region DR1, a second divided region DR2, and a third divided region DR3. The second divided region DR2 is located between the first divided region DR1 and the third divided region DR3, and the third divided region DR3 is located on a positive side of the first divided region DR1 in the x-axis direction. The first divided region DR1 and the second divided region DR2 are separated by a boundary line BD12, and the second divided region DR2 and the third divided region DR3 are separated by a boundary line BD23. The boundary line BD12 and the boundary line BD23 are parallel to the y-axis direction.

Each of the first divided region DR1 and the third divided region DR3 has a shape obtained by rounding one corner of a rectangle, whereas the second divided region DR2 has a rectangular shape. Thus, in the present embodiment, shapes of two divided regions adjacent to each other are different from each other in the display region DR.

As illustrated in FIG. 3, in each divided region, the maximum width in the x-axis direction is larger than the maximum height in the y-axis direction. In the first divided region DR1, the maximum width w1 is larger than the maximum height h1. Similarly, in the second divided region DR2, the maximum width w2 is larger than the maximum height h2, and in the third divided region DR3, the maximum width w3 is larger than the maximum height h3. In other words, relationships of w1>h1, w2>h2, and w3>h3 are satisfied. In the present embodiment, h1=h2=h3, and a relationship of w3>w1>w2 is satisfied.

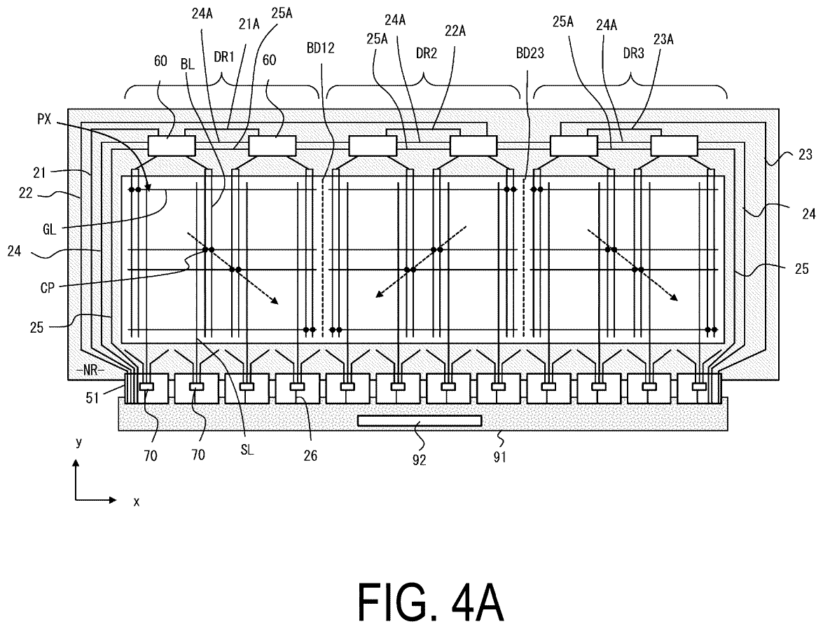

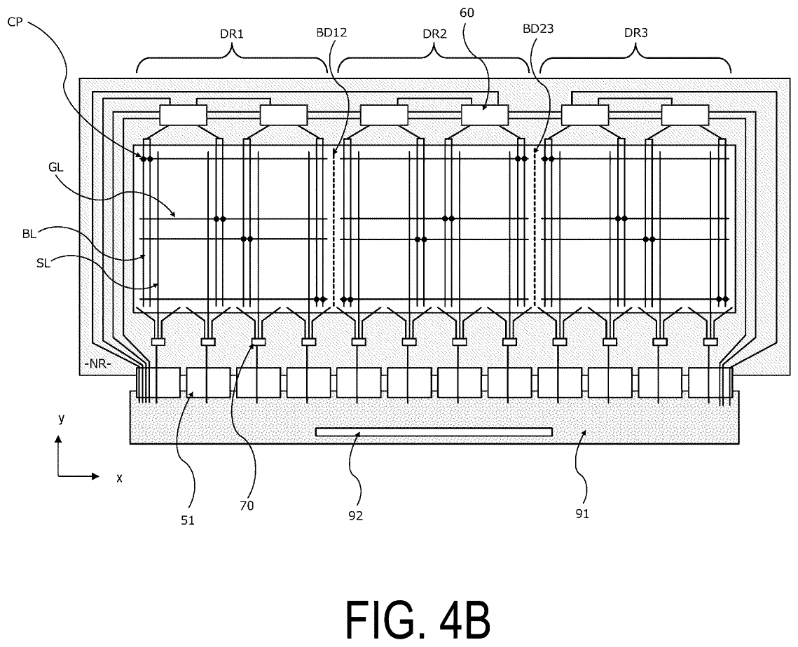

FIG. 4A is a schematic plan view of the active matrix substrate 40. In FIG. 4A, for ease of understanding, the first divided region DR1 and the second divided region DR2 are illustrated as rectangles. For the sake of description, the first divided region DR1, the second divided region DR2, and the third divided region DR3 are illustrated in the same shape.

The active matrix substrate 40 includes a plurality of scanning lines GL, a plurality of data lines SL, a plurality of scanning line connection wiring lines BL, and a plurality of pixels PX in each of the first divided region DR1, the second divided region DR2, and the third divided region DR3.

In each divided region, the plurality of scanning lines GL extend in the x-axis direction and are arrayed in the y-axis direction. The plurality of data lines SL extend in the y-axis direction and are arrayed in the x-axis direction. The plurality of scanning line connection wiring lines BL extend in the y-axis direction and are arrayed in the x-axis direction. The scanning lines GL in each divided region are not connected to the scanning lines GL in an adjacent divided region.

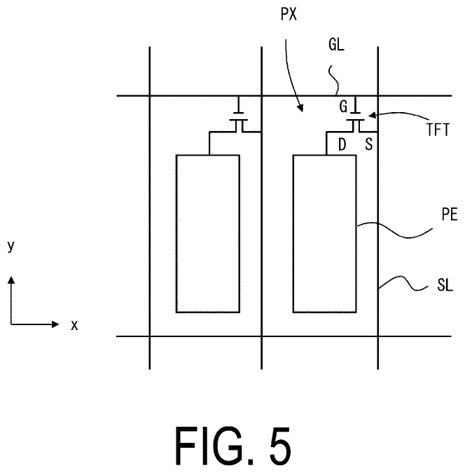

FIG. 5 is a circuit diagram illustrating a configuration example of the pixels PX. Each pixel PX is disposed in a region surrounded by a pair of data lines SL of the plurality of data lines SL and a pair of scanning lines GL of the plurality of scanning lines GL. The pixel PX includes a TFT and a pixel electrode PE. Specifically, a gate electrode of the TFT is connected to the scanning line GL, a source electrode is connected to the data line SL, and a drain electrode D is connected to the pixel electrode.

As illustrated in FIG. 4A, the plurality of scanning line drive circuits 60 are disposed to correspond to each of the first divided region DR1, the second divided region DR2, and the third divided region DR3. The plurality of data line drive circuits 70 are also disposed to correspond to each of the first divided region DR1, the second divided region DR2, and the third divided region DR3.

The plurality of scanning line drive circuits 60 and the plurality of data line drive circuits 70 are respectively arrayed in the x-axis direction outside the display region DR. In the present embodiment, the scanning line drive circuits 60 and the data line drive circuits 70 are located across a respective one of the first divided region DR1, the second divided region DR2, and the third divided region DR3, and are arrayed in the x-axis direction. The scanning line drive circuits 60 are disposed in the non-display region NR located on a positive side of each divided region in the y-axis direction. On the other hand, the data line drive circuits 70 are disposed on the flexible substrate 51 connected to the non-display region NR located on a negative side of each divided region in the y-axis direction. However, as illustrated in FIG. 4B, the plurality of data line drive circuits 70 may be disposed in the non-display region NR.

In the present embodiment, the scanning line drive circuit 60 is integrally (monolithically) formed on the substrate 10. For example, the scanning line drive circuit 60 includes a plurality of TFTs, and these TFTs and the TFT of the pixel PX are formed at the same time. The scanning line drive circuit 60 may be constituted by a bare chip or a packaged chip, and may be mounted in the non-display region NR of the substrate 10. The scanning line drive circuit 60 may be constituted by a bare chip or a packaged chip and mounted on a flexible substrate, and the flexible substrate may be mounted in the non-display region NR of the substrate 10.

The data line drive circuit 70 is constituted by a bare chip or a packaged chip, and is mounted on the flexible substrate 51. The data line drive circuit 70 may be constituted by a bare chip or a packaged chip, and may be mounted in the non-display region NR of the substrate 10.

In FIG. 4A, in each divided region, the scanning line drive circuits 60 are illustrated as two elements, but the number of the scanning line drive circuits in each divided region may be one or three or more. The same applies to the data line drive circuits 70. In each divided region, the data line drive circuits 70 are illustrated as four elements, but the number of the scanning line drive circuits in each divided region may be from one to three or five or more.

In each divided region, one end of each of the plurality of data lines SL extends to the non-display region NR and is connected to the data line drive circuit 70 via a wiring line formed on the flexible substrate 51. One end of each of the plurality of scanning line connection wiring lines BL extends to the non-display region NR and is connected to the scanning line drive circuit 60 in each divided region. Each of the plurality of scanning line connection wiring lines BL is connected at a connection point CP disposed at a position of intersection with one of the plurality of scanning lines GL. In the present embodiment, for redundancy, a pair of scanning line connection wiring lines BL adjacent to each other are connected to the same scanning line GL. The same scanning signal is applied to the pair of scanning line connection wiring lines BL adjacent to each other. With such a configuration, even when one scanning line connection wiring line BL is disconnected or the connection between the scanning line connection wiring line BL and the scanning line GL at the connection point CP is defective at the time of manufacturing the display device 101, the connection between the scanning line drive circuit and the scanning line GL can be secured by the other scanning line connection wiring line BL.

Since the scanning line connection wiring line BL is disposed in the pixel as described later, an aperture ratio of the pixel decreases. Thus, the scanning line connection wiring line BL preferably extends in the y-axis direction from a side closer to the scanning line drive circuit 60 to the opposite side of the scanning line drive circuit 60 beyond the connection point CP so that the aperture ratios of the pixels arrayed in the y-axis direction do not largely change. For example, in each divided region, each of 70% or more of the scanning line connection wiring lines of the plurality of scanning line connection wiring lines preferably has a length of 70% or more of the width of the display region in the y-axis direction.

The number of the plurality of scanning lines GL disposed in one of a pair of divided regions adjacent to each other is preferably equal to the number of the plurality of scanning lines GL disposed in the other of the pair of divided regions. Accordingly, the number of pixels in the y-axis direction is equal in the pair of divided regions adjacent to each other. When the heights of the divided regions in the y-axis direction are equal to each other, in a case in which one integrated image is displayed in the first divided region DR1, the second divided region DR2, and the third divided region DR3, that is, in the entire display region DR, the image can be displayed with a uniform pixel density in the entire display region.

The timing controller 92 is electrically connected to the scanning line drive circuit 60 by the flexible substrate 51 connected to the substrate 91 and a plurality of wiring lines disposed in the non-display region NR of the substrate 10. Examples of the plurality of wiring lines include a plurality of start signal wiring lines 21 to 23, 21A to 23A, clock signal wiring lines 24 and 24A, and constant voltage wiring lines 25 and 25A. Although the clock signal wiring lines 24 and 24A are illustrated as one line, the clock signal wiring lines 24 and 24A may include, for example, a plurality of clock signal wiring lines having different phases.

Further, the constant voltage wiring lines 25 and 25A may include, for example, a power source wiring line for applying a drive voltage and a common wiring line for applying a scanning line voltage. The scanning line voltage may include a high-level voltage Vgh for turning on the TFT and a low-level voltage Vgl for turning off the TFT.

In order for the timing controller 92 to independently output the start signal to the scanning line drive circuit 60 in each divided region, the scanning line drive circuits 60 in the first divided region DR1, the second divided region DR2, and the third divided region DR3 are connected to the timing controller 92 by the start signal wiring lines 21, 22, and 23, respectively. Further, in the present embodiment, two scanning line drive circuits 60 are disposed in each divided region, and thus the two scanning line drive circuits 60 in each of the first divided region DR1, the second divided region DR2, and the third divided region DR3 are connected to each other by cascade start signal wiring lines 21A, 22A, and 23A, respectively. The start signal defines a timing to start scanning of the scanning lines in each divided region.

On the other hand, a clock signal that defines a timing (speed) to scan the scanning lines GL in each divided region, power supply voltage supplied to the scanning line drive circuit 60, the scanning line voltage, and the like may be a common value or the same signal with respect to the scanning line drive circuit 60 in each divided region. Thus, the clock signal wiring line 24 and the constant voltage wiring line 25 are connected to, for example, the timing controller 92 and one scanning line drive circuit 60 in at least one of the divided regions, and the scanning line drive circuit 60 to which the clock signal wiring line 24 and the constant voltage wiring line 25 are connected and another scanning line drive circuit 60 in the same divided region and the scanning line drive circuit 60 in the other divided regions are connected to each other by the clock signal wiring line 24A and the constant voltage wiring line 25A. That is, the scanning line drive circuits 60 in the pair of divided regions adjacent to each other are connected to each other by the clock signal wiring line 24A and the constant voltage wiring line 25A. When the scanning line drive circuits 60 in different divided regions are connected to each other by the clock signal wiring line 24A and the constant voltage wiring line 25A, the number of wiring lines between the control device 90 including the timing controller 92 and the active matrix substrate 40 can be reduced.

Similarly, the timing controller 92 is electrically connected to the data line drive circuit 70 by the plurality of wiring lines formed on the flexible substrate 51. The wiring lines include an image signal wiring line for transmitting an image signal. In order to suppress deterioration of liquid crystal or the like, the display device 101 may perform reverse polarity driving. In this case, the plurality of wiring lines may include a control signal wiring line 26 that transmits an output polarity control signal for alternately reversing a polarity of a data signal output from the data line drive circuit 70.

FIG. 25 is a block diagram collectively illustrating control signals for driving a pixel. The timing controller 92 of the control device 90 receives a first video signal, a second video signal, and a third video signal from the host computer in the vehicle in order to display a first image, a second image, and a third image which are independent of each other in the first divided region DR1, the second divided region DR2, and the third divided region DR3, respectively. As will be described later, at least one of the first to third video signals has a frame frequency different from those of the other two video signals. Each video signal includes a video data signal (V Data) and a video synchronization signal (V Sync). Although the timing controller 92 is illustrated as one element in FIG. 25, the timing controller 92 may be divided into three elements corresponding to the divided regions, respectively.

The timing controller 92 generates the image signal and the start signal from each video data signal and each video synchronization signal, and outputs them to the data line drive circuit 70 and the scanning line drive circuit 60, respectively. Further, the control device 90 supplies the scanning line voltage to the scanning line drive circuit. The scanning line voltage includes an off voltage VgL for turning off the TFT and an on voltage VgH for turning on the TFT. For example, the off voltage VgL is −6 V, and the on voltage VgH is +20 V.

The data line drive circuit 70 receives the image signal, generates the data signal, and outputs the data signal to the data line SL. The data signal is composed of voltage values corresponding to luminance gray scales for R, G, and B, respectively. When the display device 101 performs the reverse polarity driving, for example, the voltage value of the data signal is in a range from 0 v to 12 V with 6 V as a reference. That is, 3V and 9V of the data signal indicate the same luminance gray scale although their polarities are reversed to each other. For simplicity, it is assumed that the TFT has ideal characteristics. In an actual TFT, voltage adjustment is appropriately performed so that the same luminance gray scale is obtained in the positive polarity and the negative polarity. The scanning line drive circuit 60 receives the start signal, generates the scanning signal, and outputs the scan signal to the scanning line GL. The scanning signal is composed of two values of the off voltage VgL and the on voltage VgH.

A gate of the TFT of each pixel is connected to the scanning line GL and a source thereof is connected to the data line SL, so that the TFT of each pixel is turned on at the timing of the on voltage VgH of the scanning signal. Thus, a predetermined voltage of the data signal applied to the source is applied to the pixel electrode PE via a drain of the TFT.

A reference voltage is applied to a common electrode 15 (FIG. 15). For example, a voltage of 6 V is applied. As a result, a pixel application voltage, which is a voltage difference between the voltages applied to the pixel electrode PE and the common electrode 15, is applied to the liquid crystal layer 81 sandwiched between the common electrode 15 and the pixel electrode PE, and the liquid crystal is aligned in accordance with the value of the pixel application voltage.

The timing controller 92 generates the start signals and the image signals from the video synchronization signals and video data signals of the first to third video signals, respectively, and controls the scanning line drive circuit 60 and the data line drive circuit 70 so that at least one of the first image, the second image, and the third image is displayed at a frame frequency different from those of the other two images. For example, the first image is an image displaying various meters of the automobile, such as a speedometer and a tachometer, and includes a fast motion image. Thus, the first image is displayed at a frame frequency of 120 Hz. The second image is an image of map information obtained by a car-navigation system, and there are few fast motion image changes. Thus, the second image is displayed at a frame frequency of 10 Hz. The third image is a general TV such as a relay image of sports or video image. Thus, the third image is displayed at a frame frequency of 60 Hz.

According to the display device 101, an image can be displayed in some of the divided regions of the display region DR at a frame frequency different from that of the other regions. Thus, power consumption can be reduced by lowering the frame frequency of the image displayed in some of the divided regions. At this time, by displaying an image at a high frame frequency in the other divided regions, smooth display can be performed even in the case of fast motion, and both high quality display and low power consumption can be achieved.

Since the plurality of scanning line drive circuits are arrayed in the x-axis direction outside the display region, and the scanning line and the scanning line drive circuit are electrically connected to each other using the scanning line connection wiring line extending in the same direction as the data line, the scanning line drive circuit can be prevented from being disposed at an end portion of the scanning line, that is, at a position adjacent to the divided region in the x-axis direction. Accordingly, the divided regions adjacent to each other can be disposed in contact with each other. Thus, a break of the images displayed in the divided regions can be made not noticeable. For example, when the first image, the second image, and the third image integrally form one image, a region between the divided regions where the image is not displayed can be reduced or eliminated, and excellent display can be performed.

As described above, when the first image, the second image, and the third image integrally form one image, that is, when one image is displayed in the entire display region DR, a difference in luminance preferably does not occur at the boundary between the divided regions. In order to perform such display, the position of the connection point CP between the scanning line connection wiring line BL and the scanning line GL preferably satisfies a specific relationship between the divided regions. This relationship will be described in detail below.

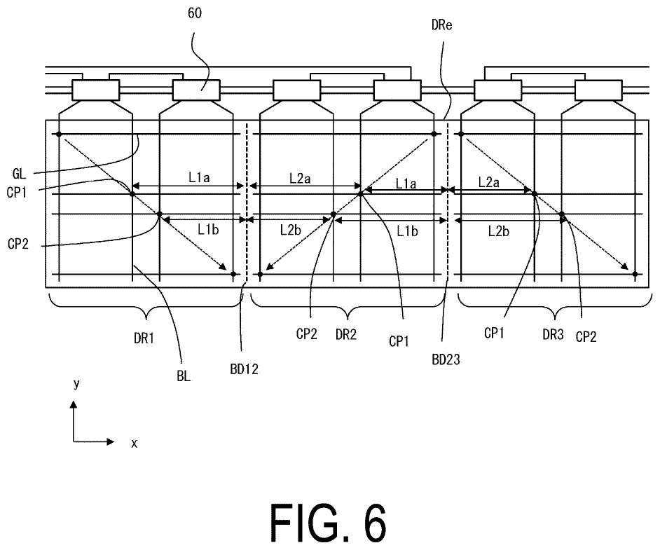

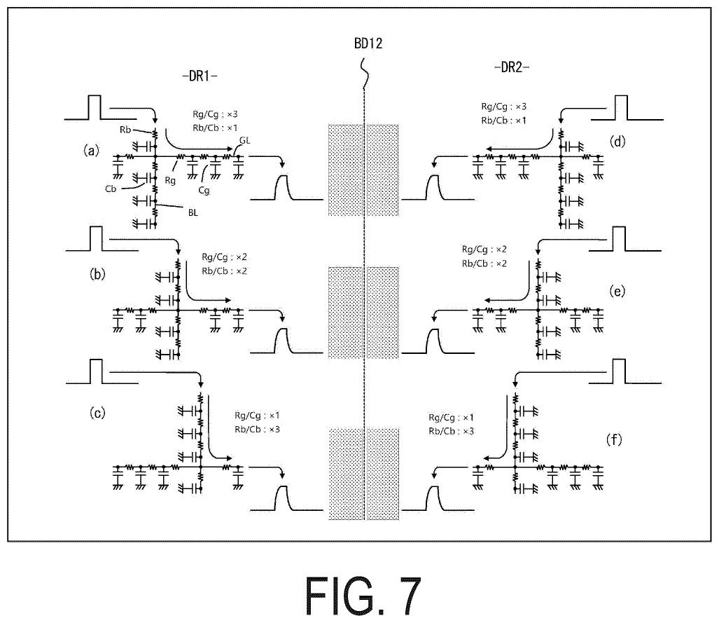

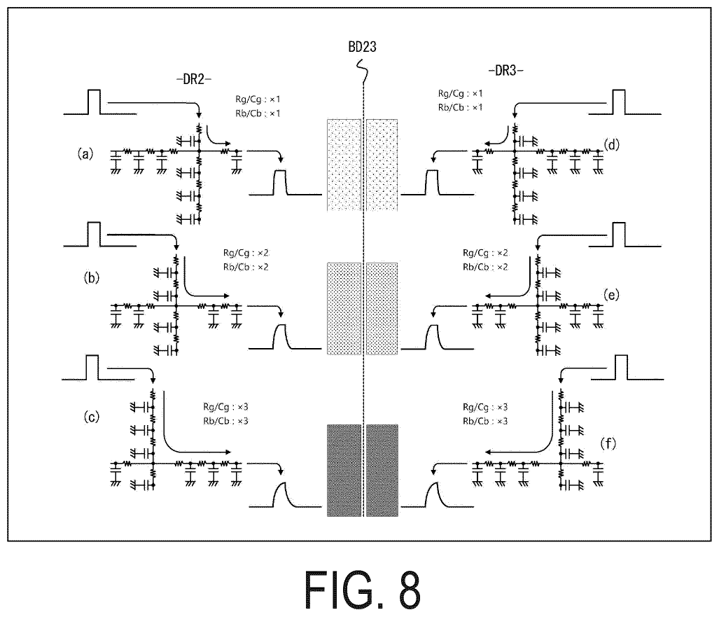

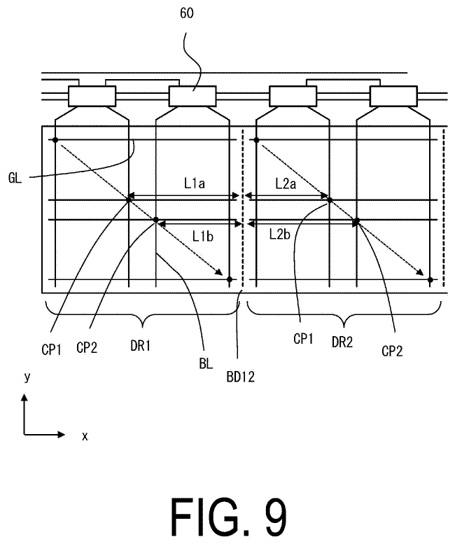

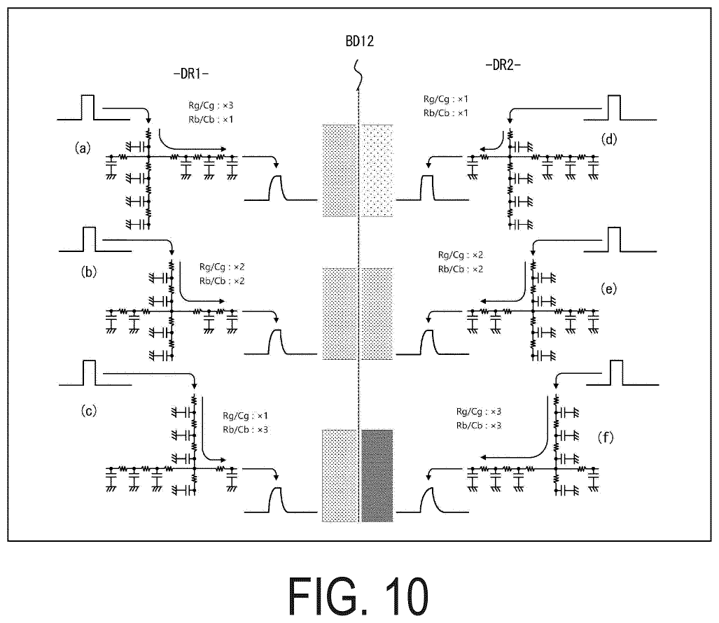

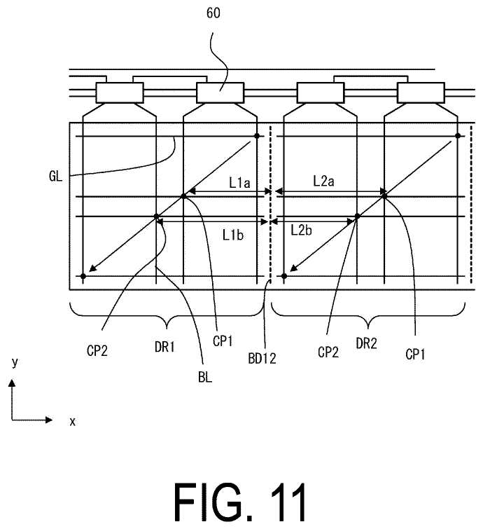

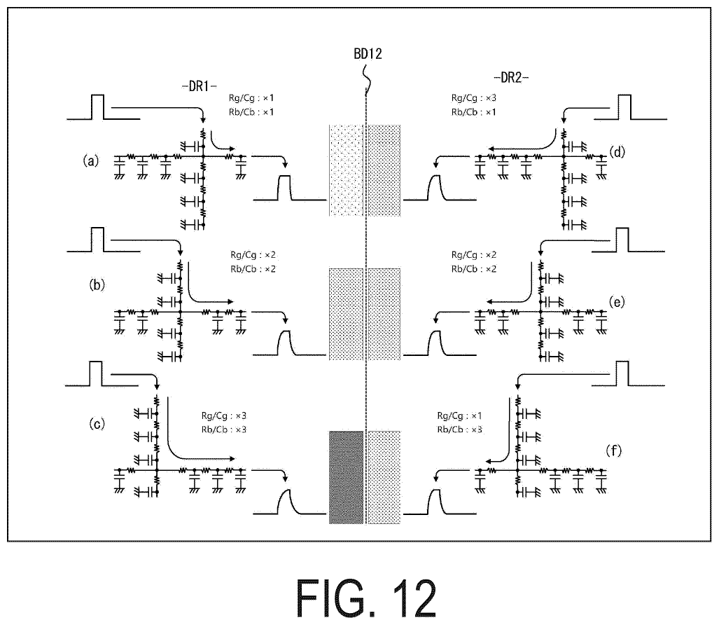

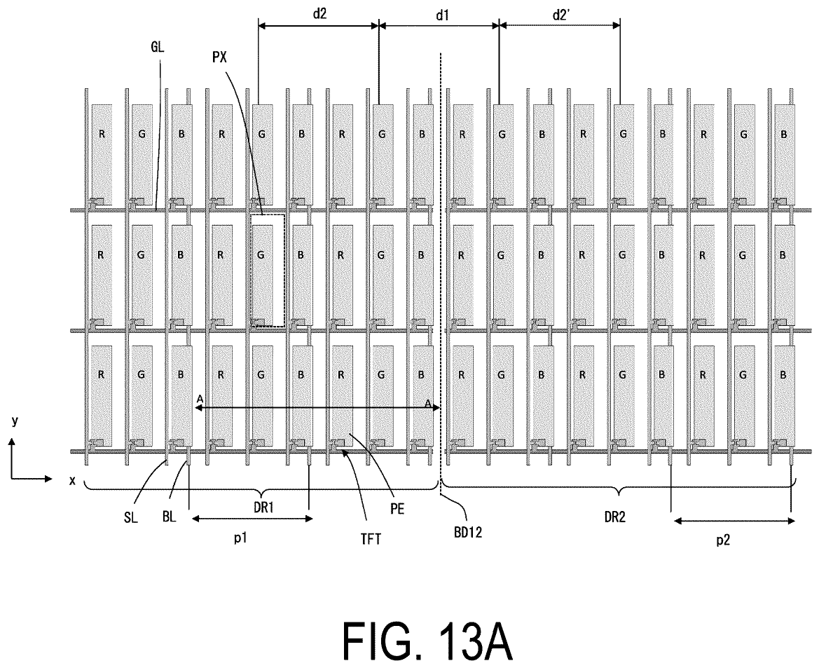

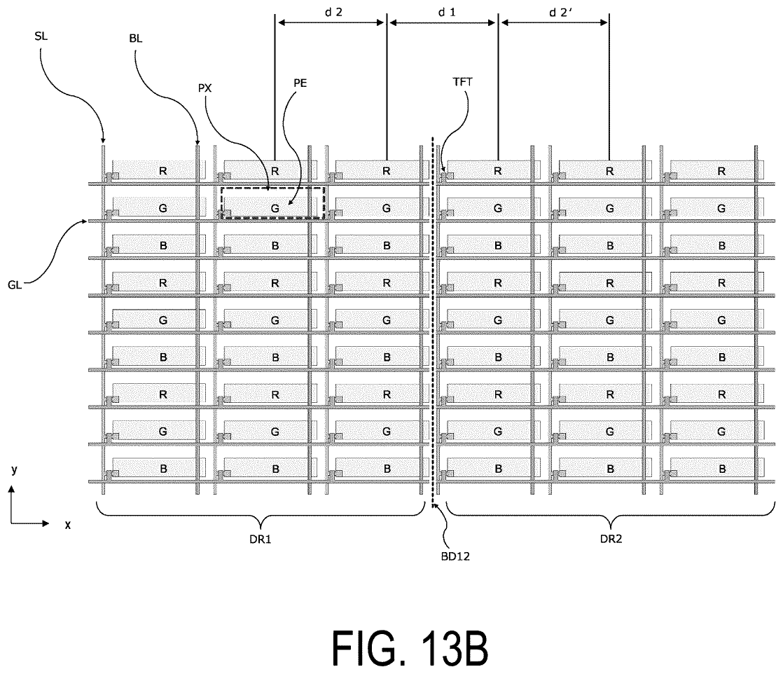

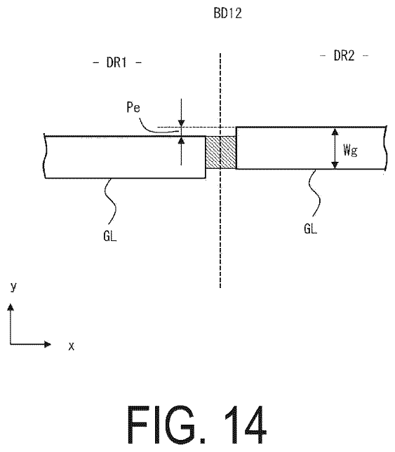

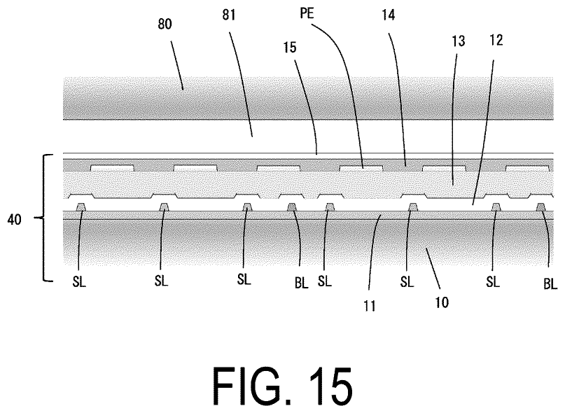

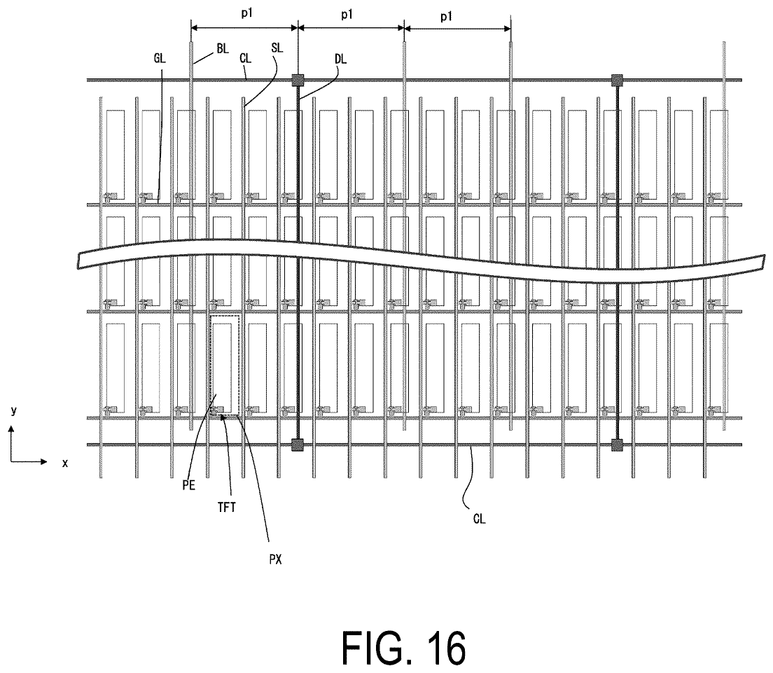

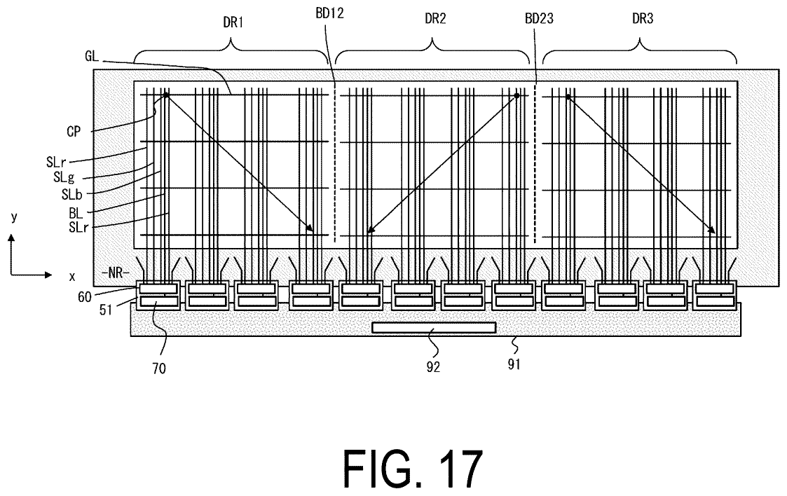

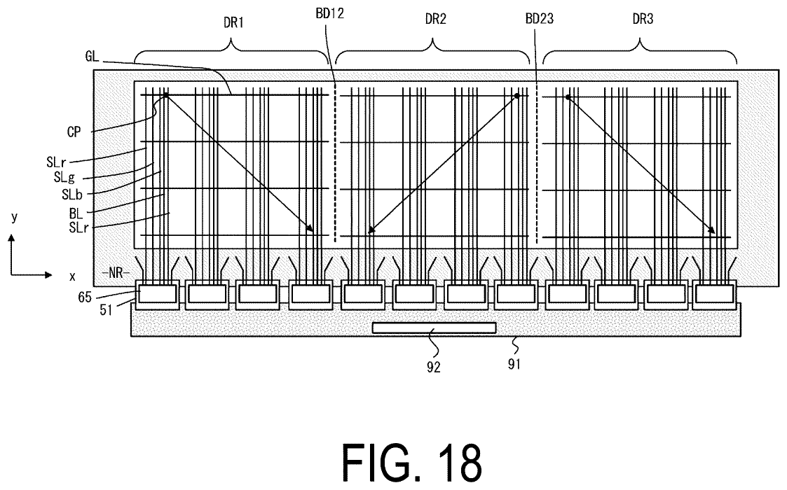

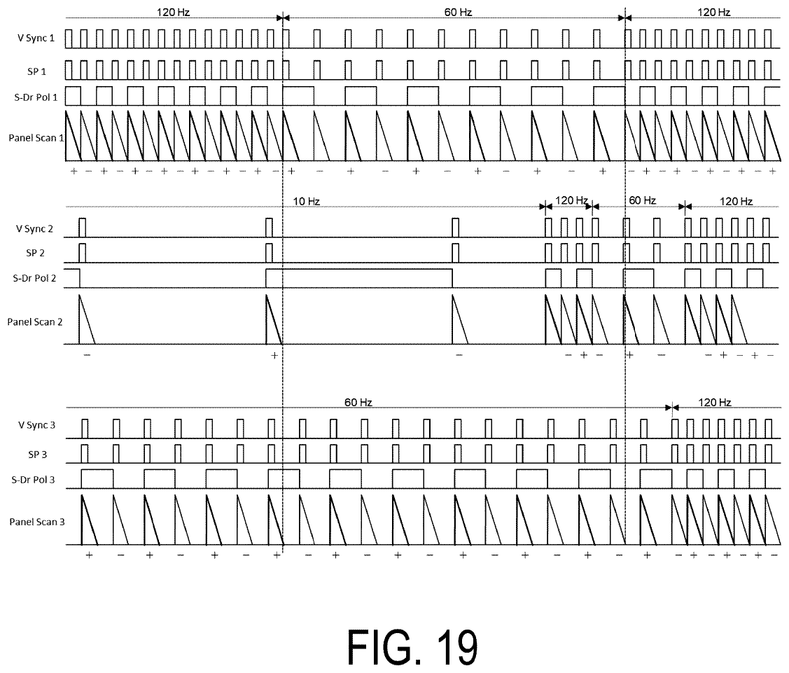

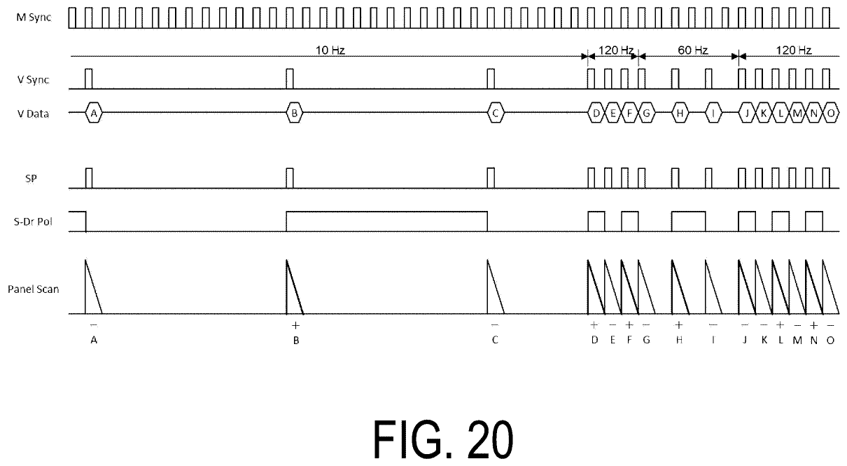

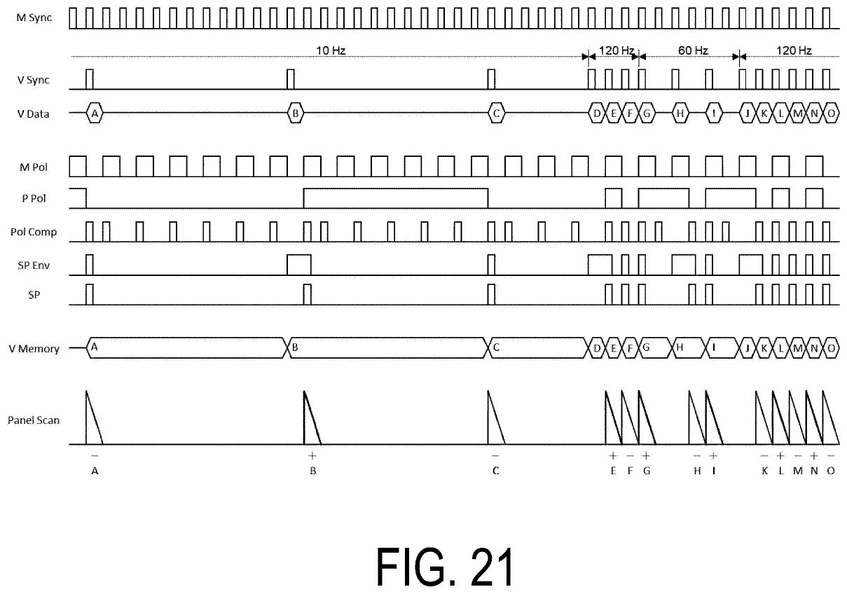

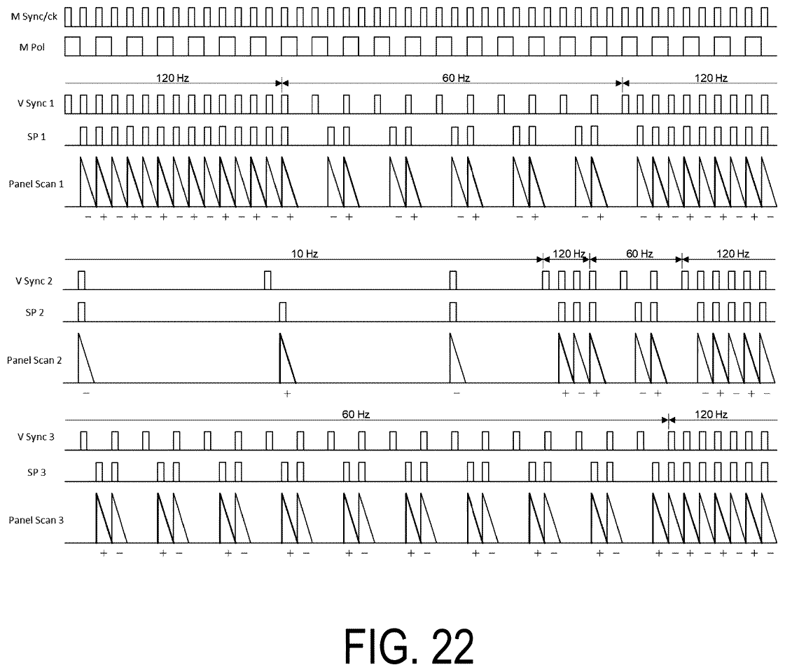

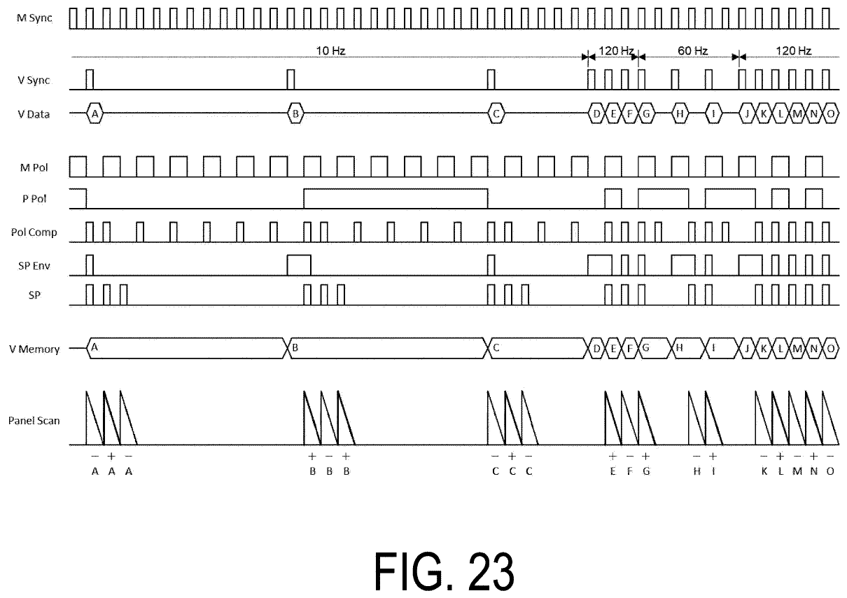

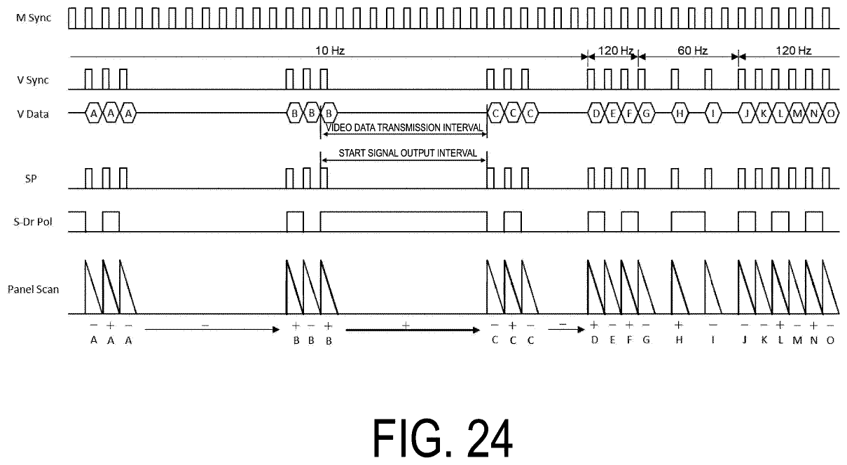

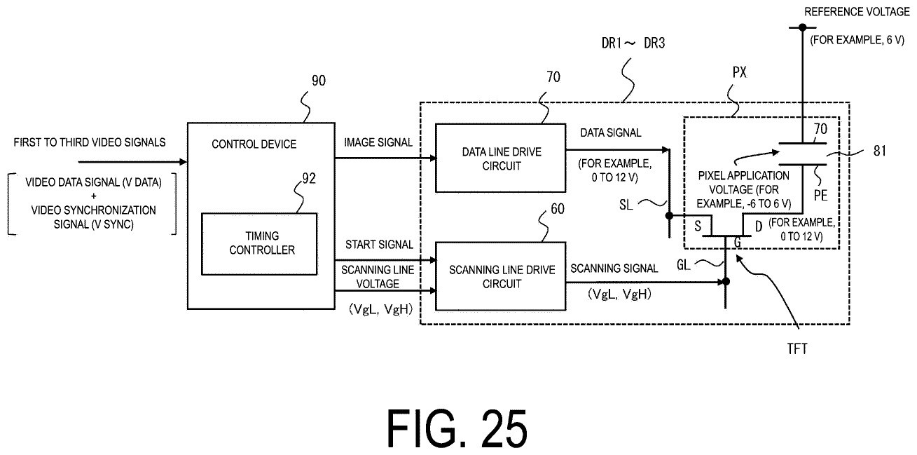

FIG. 6 illustrates an arrangement of scanning lines GL, scanning line connection wiring lines BL, and connection points CP in each divided region. In each divided region, a certain one connection point CP1 of the plurality of connection points CP which are disposed is determined, and another connection point CP2 disposed at a position farther from an upper end DRe of the display region DR than the connection point CP1 is determined.

Distances between the connection points CP1 and CP2 located in one of the pair of divided regions adjacent to each other across the boundary lines BD12 and BD23 and the boundary line are denoted by L1a and L1b, respectively, and distances between the connection points CP1 and CP2 located in the other of the pair of divided regions and the boundary line are denoted by L2a and L2b, respectively.

In the present embodiment, the distances L1a, L1b, L2a, and L2b satisfy a relationship of the following Expression (1).

(L1b−L1a)×(L2b−L2a)>0 (1)

For example, in FIG. 6, connection points CP1 and CP2 disposed in the first divided region DR1 and the second divided region DR2 are considered. The distances L1a, L1b, L2a, and L2b between the boundary line BD12 located between the first divided region DR1 and the second divided region DR2 and the connection points are such that L1a>L1b in the first divided region DR1 and L2a>L2b in the second divided region DR2. Thus, the relationship of Expression (1) is satisfied.

Similarly, connection points CP1 and CP2 disposed in the second divided region DR2 and the third divided region DR3 are considered. The distances L1a, L1b, L2a, and L2b between the boundary line BD23 located between the second divided region DR2 and the third divided region DR3 and the connection points are such that L1a<L1b in the second divided region DR2 and L2a<L2b in the third divided region DR3. Thus, the relationship of Expression (1) is satisfied.

That is, when the relationship of the distances between the connection points CP1 and CP2 and the boundary line is L1a>L1b or L2a>L2b with an arrangement pattern of the connection points being denoted by A, and L1a<L1b or L2a<L2b with an arrangement pattern of the connection points being denoted by B, an arrangement pattern of AA or BB on the left side and the right side of the boundary line satisfies the relationship of Expression (1).

A scanning signal for turning on/off each pixel PX output from the scanning line drive circuit is applied to the scanning line connection wiring line BL and the scanning line GL. The scanning signal has a pulse waveform when it is output from the scanning line drive circuit. However, due to a parasitic resistance and a parasitic capacitance corresponding to a distance from the scanning line drive circuit to the pixel PX, the waveform is rounded, and an effective time during which the pixel PX is turned on is shortened. As a result, the luminance of the pixel decreases in accordance with the parasitic resistance and the parasitic capacitance. In the two divided regions adjacent to each other across the boundary line, the influence of the parasitic resistance and the parasitic capacitance on the pixel in each divided region closest to the boundary line can be evaluated as follows.

As illustrated in FIG. 7, in each divided region, the scanning line GL and the scanning line connection wiring line BL are divided into four parts, and in the divided parts, parasitic resistances are denoted by Rg and Rb, respectively, and parasitic capacitances are denoted by Cg and Cb, respectively.

(a), (b) and (c) of FIG. 7 in the first divided region DR1 and (d), (e) and (f) of FIG. 7 in the second divided region DR2 schematically illustrate the position of the connection point CP between the scanning line connection wiring line BL and the scanning line GL, and the parasitic resistances Rg and Rb and the parasitic capacitances Cg and Cb located from the scanning line drive circuit to the pixel adjacent to the boundary line BD12 and affecting the scanning line. Each of (a) and (d) illustrates the scanning line GL in an upper portion of a respective one of the divided region in the y-axis direction, each of (b) and (e) illustrates the scanning line GL in a central portion of a respective one of the divided region in the y-axis direction, and each of (c) and (f) illustrates the scanning line GL in a lower portion of a respective one of the divided region in the y-axis direction.

As illustrated in FIG. 7, when it is assumed that Rg/Cg and Rb/Cb are equal to each other, the parasitic resistance and the parasitic capacitance affecting the pixel adjacent to the boundary line BD12 correspond to four of Rg/Cg or Rb/Cb in any of (a) to (f). Thus, the rounding of the waveform of the scanning signal applied to the pixel closest to the boundary line BD12 in the first divided region DR1 and the rounding of the waveform of the scanning signal applied to the pixel closest to the boundary line BD12 in the second divided region DR2 are substantially the same, and the pixels are affected by the parasitic resistance and the parasitic capacitance to substantially the same extent. Thus, the decrease in luminance of the pixels due to the parasitic resistance and the parasitic capacitance is also substantially the same, and the pixels emit light with substantially the same luminance. In FIG. 7 and the following FIGS. 8, 10, and 12, rectangles of hatching indicate the luminance of pixels, and the lighter the hatching is, the higher the luminance is. Thus, the luminance difference between the pixels across the boundary line BD12 is small, and the boundary line is hardly noticeable. In the first divided region DR1, the luminance of the pixels adjacent to the boundary line BD12 is substantially the same regardless of the position in the y-axis direction.

FIG. 8 is diagrams illustrating the influence of the parasitic resistance and the parasitic capacitance on the pixels adjacent to the boundary line BD23 between the second divided region DR2 and the third divided region DR3. In the second divided region DR2 and the third divided region DR3, the influence of the parasitic resistance and the parasitic capacitance on the pixels varies depending on the position in the y-axis direction. That is, the influence of the parasitic resistance and the parasitic capacitance increases as the pixel is located at a lower position, that is, as the pixel is located on the negative side along the y-axis direction.

Specifically, as illustrated in (a) and (d), the pixel in each divided region connected to the scanning line GL in the upper portion in the y-axis direction is affected by the parasitic resistance and the parasitic capacitance corresponding to two of Rg/Cg or Rb/Cb. As illustrated in (b) and (e), the pixel in each divided region connected to the scanning line GL in the central portion in the y-axis direction is affected by the parasitic resistance and parasitic capacitance corresponding to four of Rg/Cg or Rb/Cb. As illustrated in (c) and (f), the pixel in each divided region connected to the scanning line GL in the lower portion in the y-axis direction is affected by the parasitic resistance and the parasitic capacitance corresponding to six of Rg/Cg or Rb/Cb.

Thus, in each of the second divided region DR2 and the third divided region DR3, as the pixel adjacent to the boundary line BD23 is located in the lower direction, the rounding of the waveform of the applied scanning signal becomes larger and the luminance of the pixel becomes lower. However, when the positions in the y-axis direction are the same, the influence of the parasitic resistance and the parasitic capacitance on the pixels closest to the boundary line BD12 is substantially the same between the second divided region DR2 and the third divided region DR3. Thus, the luminance difference between the pixels across the boundary line BD23 is small, and the boundary line is hardly noticeable.

FIG. 9 illustrates an example in which the distances L1a, L1b, L2a, and L2b do not satisfy Expression (1). As illustrated in FIG. 9, with respect to the boundary line BD12, for example, it is assumed that the relationship of L1a>L1b is satisfied in the first divided region DR1 and the relationship of L2a<L2b is satisfied in the second divided region DR2. That is, an arrangement pattern of AB is satisfied. In this case, as illustrated in (a) and (d) of FIG. 10, in the upper portion in the y-axis direction, the pixel of the first divided region DR1 adjacent to the boundary line BD12 is more affected by the parasitic resistance and the parasitic capacitance than the pixel of the second divided region DR2 adjacent to the boundary line BD12, and the luminance decreases. Thus, the boundary line BD12 due to the luminance difference is noticeable.

As illustrated in (c) and (f) of FIG. 10, in the lower portion in the y-axis direction, the pixel of the second divided region DR2 adjacent to the boundary line BD12 is more affected by the parasitic resistance and the parasitic capacitance than the pixel of the first divided region DR1 adjacent to the boundary line BD12, and the luminance decreases. Thus, the boundary line BD12 due to the luminance difference is noticeable.

As illustrated in FIG. 11, with respect to the boundary line BD12, for example, it is assumed that the relationship of L1a<L1b is satisfied in the first divided region DR1 and the relationship of L2a>L2b is satisfied in the second divided region DR2. That is, an arrangement pattern of BA is satisfied. In this case, as illustrated in (a) and (d) of FIG. 12, in the upper portion in the y-axis direction, the pixel of the second divided region DR2 adjacent to the boundary line BD12 is more affected by the parasitic resistance and the parasitic capacitance than the pixel of the first divided region DR1 adjacent to the boundary line BD12, and the luminance decreases. Thus, the boundary line BD12 due to the luminance difference is noticeable.

As illustrated in (c) and (f) of FIG. 12, in the lower portion in the y-axis direction, the pixel of the first divided region DR1 adjacent to the boundary line BD12 is more affected by the parasitic resistance and the parasitic capacitance than the pixel of the second divided region DR2 adjacent to the boundary line BD12, and the luminance decreases. Thus, the boundary line BD12 due to the luminance difference is noticeable.

As described above, according to the display device 101, when the position of the connection point between the scanning line GL and the scanning line connection wiring line BL satisfies the relationship of Expression (1), the influence of the decrease in luminance of the pixel due to the influence of the parasitic resistance and the parasitic capacitance in the vicinity of the boundary between the two divided regions adjacent to each other is suppressed, and display can be performed in which the difference in luminance (luminance separation) hardly occurs at the boundary between the two divided regions.

In the present embodiment, although three divided regions are disposed along the x-axis direction, even when four or more divided regions are disposed, an image can be displayed in which a difference in luminance hardly occurs at any boundary line. by repeating the arrangement pattern of the connection points in the two divided regions across the boundary line as AA, BB, AA, BB, . . . . Further, in the present embodiment, the arrangement pattern of the connection points in the first divided region and the second divided region is AA, but may be BB. In this case, the arrangement pattern of the connection points in the second divided region and the third divided region is AA.

Note that in the case in which the arrangement of the connection points in two divided regions adjacent to each other satisfies Expression (1), a direction in which the scanning line drive circuit 60 scans the scanning line connection wiring lines BL is preferably such that a scanning direction of the scanning line drive circuit disposed in a region of one of the pair of divided regions adjacent to each other across the boundary line and a scanning direction of the scanning line drive circuit disposed in a region of the other are different from each other. By determining the scanning directions in this manner, the scanning directions of the scanning lines in the two divided regions adjacent to each other become equal to each other. Specifically, when the scanning lines in the region of one of the pair of divided regions adjacent to each other are scanned from top to bottom, the scanning lines in the region of the other are also scanned from top to bottom. When the scanning lines in the region of one of the pair of divided regions adjacent to each other are scanned from top to bottom, the scanning lines in the region of the other are also scanned from top to bottom.

When the relationships of L1a>L1b and L2a>L2b are satisfied, and each of the scanning line drive circuits of the pair of divided regions adjacent to each other scans a respective one of the scanning line connection wiring lines in a direction toward the boundary line, the scanning lines GL of the pair of divided regions are respectively scanned from top to bottom. When the relationships of L1a<L1b and L2a<L2b are satisfied, and each of the scanning line drive circuits of the pair of divided regions adjacent to each other scans a respective one of the scanning line connection wiring lines in a direction away from the boundary line, the scanning lines GL of the pair of divided regions are respectively scanned from top to bottom.

Next, a detailed configuration of the pixel of the display device 101 is described. FIG. 13A is an enlarged plan view illustrating a part of the active matrix substrate 40 of the display device 101. As illustrated in FIG. 13A, each of the plurality of pixels PX is any one of a red pixel (indicated by R), a green pixel (indicated by G), and a blue pixel (indicated by B) in the present embodiment. Pixels of the same color are disposed in the y-axis direction, and the red pixel, the green pixel, and the blue pixel are repeatedly disposed in this order in the x-axis direction. The arrangement of the plurality of pixels is not limited to this example, and yellow pixels and white pixels may be further included. The arrangement of the pixels may be in accordance with a Bayer array.

Further, a configuration as illustrated in FIG. 13B may be used, in which pixels of the same color are disposed in the x-axis direction, and the red pixel, the green pixel, and the blue pixel are repeatedly disposed in this order in the y-axis direction. In this configuration, although it is necessary to separate the scanning line for the red pixels, the green pixels, and the blue pixels and perform scanning three times faster than the configuration illustrated in FIG. 13A, since the red pixels, the green pixels, and the blue pixels share the data line, the number of expensive data line drive circuits can be reduced to one third.

Since the pixels of the same color are arrayed in the x-axis direction, when the liquid crystal display device has a structure in which a color filter is disposed on the counter substrate, a color shift due to a positional shift between the active matrix substrate and the counter substrate in the x-axis direction can be suppressed. For example, when such a display device is curved along the x-axis direction, a curvature radius of the active matrix substrate is different from that of the counter substrate, and thus positions of the pixels on the active matrix substrate and positions of the pixels on the counter substrate are shifted in the x-axis direction. However, since the pixels of the same color are disposed in the x-axis direction, display in different colors is suppressed even when the positions are shifted.

In the active matrix substrate 40, when a distance between a pair of pixels of the same color that are respectively included in a respective one of the pair of divided regions adjacent to each other and are closest to each other in the x-axis direction is denoted by d1, and a distance between a pair of pixels of the same color that are respectively included in one of the pair of divided regions adjacent to each other and are closest to each other in the x-axis direction is denoted by d2, d1 and d2 are preferably equal. For example, as illustrated in FIGS. 13A and 13B, when a distance between a green pixel closest to the boundary line BD12 in the first divided region DR1 and a green pixel closest to the boundary line BD12 in the second divided region DR2 is denoted by d1, and a distance between the two green pixels closest to each other in the x-axis direction of the first divided region DR1 is denoted by d2, d1=d2 is satisfied. When a distance between the two green pixels closest to each other in the x-axis direction of the second divided region DR2 is denoted by d2′, d1=d2=d2′ is more preferable.

By satisfying this relationship, the first divided region DR1 and the second divided region DR2 are continuous in the x-axis direction without disposing an extra space between two pixels across the boundary line BD12. Thus, when a continuous image is integrally displayed in the first divided region DR1 and the second divided region DR2, a break of the divided regions does not occur, and excellent display can be performed.

Each of the scanning lines disposed in one of the pair of divided regions adjacent to each other preferably overlap one of the plurality of scanning lines disposed in the other of the pair of divided regions in the y-axis direction when viewed from the x-axis direction. For example, as illustrated in FIG. 14, the scanning line GL in the first divided region DR1 overlaps the scanning line GL in the second divided region DR2 in the y-axis direction in a region indicated by oblique lines. In other words, a shift amount Pe in the y-axis direction between the scanning line GL in the first divided region DR1 and the scanning line GL in the second divided region DR2 is preferably smaller than a width Wg of the scanning line GL (Pe<Wg). More preferably, Pe<½Wg is satisfied. The scanning lines GL disposed in the second divided region DR2 and the third divided region DR3 also preferably satisfy the same relationship.

By disposing the scanning lines GL in this manner, the pixel of the first divided region DR1 and the pixel of the second divided region DR2 are prevented from being shifted in the y-axis direction at the boundary line BD12. Thus, when the continuous image is integrally displayed in the first divided region DR1 and the second divided region DR2, the break of the divided regions does not occur, and excellent display can be performed. Similarly, the pixel of the second divided region DR2 and the pixel of the third divided region DR3 are prevented from being shifted in the y-axis direction at the boundary line BD23. Thus, when the continuous image is integrally displayed in the first divided region DR1, the second divided region DR2, and the third divided region DR3, the break of the divided regions does not occur, and further excellent display can be performed.

In each divided region, the plurality of scanning line connection wiring lines BL are arrayed in the x-axis direction at an arraying pitch of pixels of the same color of the plurality of pixels PX in the x-axis direction. For example, as illustrated in FIG. 13A, in the first divided region DR1, since the arraying pitch of the green pixels in the x-axis direction is d2, an arraying pitch p1 of the scanning line connection wiring lines BL is equal to d2. Similarly, in the second divided region DR2, an arraying pitch p2 of the scanning line connection wiring lines BL is equal to d2′.

Each of the scanning line connection wiring lines BL preferably overlaps one or both of the blue pixel and the red pixel of the red pixel, the green pixel, and the blue pixel adjacent to each other in the x-axis direction. In the example illustrated in FIG. 13A, the scanning line connection wiring line overlaps the blue pixel and is disposed in the blue pixel. As described above, by disposing the scanning line connection wiring line BL, the aperture ratio of the pixel in which the scanning line connection wiring line BL is disposed decreases. Of red, blue, and green, the visibility of green is higher than those of red and blue for human eyes. Thus, when the scanning line connection wiring line BL is disposed in the green pixel to decrease the aperture ratio, the decrease in luminance is strongly perceived. Thus, by disposing the scanning line connection wiring line BL in the red pixel or the blue pixel in which the influence on the luminance due to the decrease in the aperture ratio is relatively small, the influence on the luminance due to the decrease in the aperture ratio can be further suppressed.

FIG. 15 illustrates an example of a cross-sectional structure of the liquid crystal display device taken along line A-A in FIG. 13A. In the active matrix substrate 40, a first insulating layer 11 is disposed on the substrate 10, and the data lines SL and the scanning line connection wiring lines BL are disposed on the first insulating layer 11. The data line SL and the scanning line connection wiring line BL extend in the y-axis direction and do not intersect each other. Thus, they can be made of a metal layer of the same layer. For example, by forming the metal layer so as to cover the first insulating layer 11 and performing patterning, the data line SL and the scanning line connection wiring line BL can be formed at the same time.

A second insulating layer 12 is disposed on the first insulating layer 11 so as to cover the data lines SL and the scanning line connection wiring lines BL, and an interlayer insulating layer 13 for leveling the unevenness of the second insulating layer 12 is disposed on the second insulating layer 12. The pixel electrodes PE are disposed on the interlayer insulating layer 13, and a third insulating layer 14 is disposed so as to cover the pixel electrodes PE. A common electrode 15 is disposed on the third insulating layer.

The counter substrate 80 is disposed corresponding to the active matrix substrate 40 with a predetermined distance therebetween, and the liquid crystal layer 81 is disposed between the counter substrate 80 and the active matrix substrate 40.

As described above, since the scanning line connection wiring line BL can be formed by the metal layer of the same layer as the data line SL, the scanning line connection wiring line can be formed without increasing the number of manufacturing steps.

As described above, the scanning line connection wiring lines BL are preferably arrayed in the x-axis direction at the same pitch as the arraying pitch of the pixels of the same color in the x-axis direction. According to this arrangement, when the number of pixels adjacent to each other in the x-axis direction with red, blue, and green pixels as one set is larger than the number of pixels in the y-axis direction, a pixel is generated in which the scanning line connection wiring line BL is not disposed. In this case, the aperture ratio of the pixel in which the scanning line connection wiring line BL is not disposed becomes high, and the aperture ratios of the pixels in each divided region are not uniform.

In such a case, the active matrix substrate 40 may further include at least one dummy scanning line connection wiring line extending in the y-axis direction and arrayed in the x-axis direction. FIG. 16 is a schematic enlarged plan view of an active matrix substrate 40′ further including dummy scanning line connection wiring lines DL. The scanning line connection wiring lines BL and the dummy scanning line connection wiring lines DL are disposed at the arraying pitch p1 of the scanning line connection wiring lines BL described above in the x-axis direction. That is, when the scanning line connection wiring line BL is disposed in the blue pixel, the dummy scanning line connection wiring line DL is also disposed in the blue pixel.

As a result, either the scanning line GL or the dummy scanning line connection wiring line DL is disposed in the blue pixel. Thus, the aperture ratio of the blue pixel can be prevented from varying from place to place.

Since the dummy scanning line connection wiring line DL is not involved in the driving of the scanning line GL, the dummy scanning line connection wiring line DL is connected to neither the scanning line drive circuit 60 nor the scanning line GL. However, in a case in which the dummy scanning line connection wiring line DL is a floating electrode not connected to any potential, problems may occur such that static electricity is accumulated and a potential difference due to a difference in the amount of charges accumulated between the dummy scanning line connection wiring lines DL is generated. Thus, the active matrix substrate 40 preferably further includes at least one common wiring line CL extending in the x-axis direction, and each dummy scanning line connection wiring line DL is preferably connected to the at least one common wiring line CL. The common wiring line CL is connected to an electrode to which a predetermined potential such as a reference potential is applied. The plurality of dummy scanning line connection wiring lines DL may be connected to the same common wiring line CL.

The common wiring line CL intersects, for example, the scanning line connection wiring line BL. The common wiring line CL intersects the data line.

As described above, by disposing the dummy scanning line connection wiring line DL in the pixel in which the scanning line connection wiring line BL is not disposed, the aperture ratio of the pixel can be made constant.

When the number of pixels adjacent to each other in the x-axis direction with red, blue, and green pixels as one set is twice or more the number of pixels in the y-axis direction, a configuration may be adopted in which as illustrated in FIG. 4A, the scanning line connection wiring lines have redundancy and two scanning line connection wiring lines BL adjacent to each other are connected to the same scanning line GL, and the dummy scanning line connection wiring line DL may be further provided if necessary.

In the display device 101 of the disclosure, various modifications are possible. First, in the above-described embodiment, the display device is the liquid crystal display device, but may be a display device having another structure such as the organic EL display device as described above. The display device of the disclosure can be suitably used in display devices having various structures in which a pixel connected to a scanning line selected by selectively applying a scanning signal to the scanning line is turned on, and each pixel lights up with luminance according to the data signal supplied from the data line.

In the present embodiment, the scanning line drive circuit 60 and the data line drive circuit 70 face each other across each divided region. However, the scanning line drive circuit 60 may be disposed on the same side as the data line drive circuit 70 with respect to each divided region.

For example, as illustrated in FIG. 17, the scanning line drive circuits may be disposed on the same flexible substrate 51 as the data line drive circuits. In this case, for example, when the data lines of the plurality of data lines for driving the red pixel, the green pixel, and the blue pixel are SLr, SLg, and SLb, respectively, each of the scanning line connection wiring lines BL may be disposed adjacent to the data line SLr for driving the red pixel. For example, wiring lines connected to the data lines SLr, SLg, and SLb may be disposed on the front surface side of the flexible substrate 51, and a wiring line connected to the scanning line connection wiring line BL may be disposed on the rear surface side of the flexible substrate 51.

Further, as illustrated in FIG. 18, a drive circuit 65 in which the scanning line drive circuit and the data line drive circuit are accommodated in one package may be formed and disposed on the flexible substrate 51. That is, the drive circuit 65 may serve as both the scanning line drive circuit and the data line drive circuit. In the drive circuit 65, for example, as in FIG. 17, the data lines SL and the scanning line connection wiring line BL may be disposed in the order of the data lines SLr, SLg, and SLb and the scanning line connection wiring line BL in the x-axis direction, and may be connected to the drive circuit 65.

The shape and size of the display region DR and the number of divided regions included in the display region DR are merely examples, and the shape, size, and the number are not limited to those in the above-described embodiments.

### Second Embodiment

A driving method of the display device according to the present embodiment will be described. FIG. 19 shows timings to scan the scanning lines GL in a case in which independent images are displayed in the first divided region DR1, the second divided region DR2, and the third divided region DR3, respectively, of the display device 101. In FIG. 19, three signal groups for displaying images (the first image, the second image, and the third image) in the first divided region DR1, the second divided region DR2, and the third divided region DR3 and scanning timing charts each representing a scanning state of the panel are shown in an upper part, a central part, and a lower part, respectively. Specifically, video synchronization signals (V sync 1, V sync 2, and V sync 3), start signals (SP 1, SP 2, and SP 3), output polarity control signals (S-Dr Pol 1, S-Dr Pol 2, and S-Dr Pol 3), and scanning timing charts (Panel Scan 1, Panel Scan 2, and Panel Scan 3) are shown in the upper part, the central part, and the lower part, respectively.

Further, in FIG. 19, the frame frequency of the image displayed in the first divided region DR1 is changed from 120 Hz to 60 Hz, and to 120 Hz. The frame frequency of the image displayed in the second divided region DR2 is changed from 10 Hz to 120 Hz, to 60 Hz, and to 120 Hz. The frame frequency of the image displayed in the third divided region DR3 is changed from 60 Hz to 120 Hz.

FIG. 20 shows timings of a master clock signal (M Sync) and a video data signal (V Data) in addition to the four signal groups in the second divided region DR2. The scanning timing chart schematically shows a scanning period and a polarity of the data signal during the scanning, not an actual signal. A thick solid line indicates that the data signal is applied with a positive (+) polarity, and a thin solid line indicates that the data signal is applied with a negative (−) polarity. Symbols “+” and “−” shown in the lower part of the scanning timing chart indicate the polarity of the data signal, and symbols “A”, “B”, “C”, and the others indicate values (contents) of the data signal. The positive and negative polarities mean whether the polarity is positive (whether the voltage is high) or negative (whether the voltage is low) with respect to a reference potential, that is, a voltage of the common electrode of the pixel. Thus, depending on the setting of the reference potential, even when the polarity is negative, the voltage actually applied may be a positive voltage. The control device 90 generates the start signal based on the video synchronization signal of the image displayed in each divided region, and outputs the start signal to the scanning line drive circuit 60 in each divided region. Further, the control device 90 reverses the output of the output polarity control signal from 0 to 1 or from 1 to 0 each time the video synchronization signal is received.

The scanning line drive circuit 60 in each divided region starts the scanning of the scanning lines GL by receiving the start signal. The scanning of the scanning lines GL is performed based on a scanning line clock signal input in common to each divided region. Thus, when the number of the scanning lines GL disposed in each divided region is equal to each other, scanning periods in which the plurality of scanning lines GL arranged in the y direction are scanned once in each divided region are equal to each other. Further, even when the frame frequency is different, the scanning line clock signal is the same, and thus the scanning period is constant and does not change. On the other hand, a length of a pause period following the scanning period changes depending on the frame frequency. The lower the frame frequency, the longer the pause period.

In the pause period, the scanning of the scanning lines GL is not performed, and the data signal displayed last is maintained. As a result, the power consumption can be reduced. The length of the pause period is preferably an integer multiple of one scanning period. in a case in which this condition is satisfied, in a pair of divided regions adjacent to each other among the first divided region DR1, the second divided region DR2, and the third divided region DR3, a relationship of Nb×Tspa=Na×Tspb is satisfied, where Tspa is an interval of the start signal applied to the scanning line drive circuit 60 in one region, Tspb is an interval of the start signal applied to the scanning line drive circuit 60 in the other region, and Na and Nb are any natural numbers. Tspa and Tspb are frame periods, and thus 1/Tspa and 1/Tspb are frame frequencies. In other words, when the frame frequency of the image displayed in each divided region is changed, when the frame frequency is selected so as to satisfy the relationship of Nb×Tspa=Na×Tspb, on/off timings of switching elements such as TFTs during the scanning can be made common in the entire display region by using the common scanning line clock signal, so that the configuration of the entire driving system of the display device 101 can be simplified. During the scanning of the scanning lines, the data signal is applied. At this time, the data line drive circuit 70 outputs the data signal with a polarity corresponding to the value of the output polarity control signal. For example, when the output polarity control signal is 1, the data signal is output with a positive polarity, and when the output polarity control signal is 0, the data signal is output with a negative polarity. As a result, the polarity of the voltage applied to the liquid crystal for each frame is reversed, and a bias of the voltage applied to the liquid crystal is suppressed. In a period in which the data line drive circuit 70 stops updating the data signal corresponding to the display image, the control device 90 stops outputting the start signal.

By performing such control, even when the frame frequency changes at any timing in each divided region, reverse of the polarity of the data signal can be maintained before and after the timing of switching of the frame frequency. The reverse of the polarity of the data signal may be performed in the entirety of each divided region, may be performed in units of scanning lines (row line-reversal), may be performed in units of data lines (column line-reversal or column-reversal), or may be performed in units of pixels (dot-reversal). When the liquid crystal panel 50 is driven by column-reversal or dot-reversal, it is preferable that the number of the plurality of data lines SL disposed in each divided region is an even number. By satisfying this condition, for example, in a usage scene in which one continuous moving picture is displayed in the three regions DR1, DR2, and DR3 at the same frame frequency. the polarities of the data signals applied to a pair of pixel columns closest to the boundary lines BD12 or BD23 between the pair of divided regions adjacent to each other are always opposite to each other. In other words, it is possible to prevent the polarities of the data signals applied to the pair of pixel columns closest to the boundary lines BD12 or BD23 between the pair of divided regions adjacent to each other from being the same. Thus, deterioration of display quality of the moving picture such that continuity of the polarity is collapsed in the vicinity of the boundary lines BD12 and BD23 and the boundary line is visually recognized can be suppressed.

In the display device 101, the host computer in the vehicle determines the contents and frame frequencies of the first, second, and third images to be displayed in the first, second, and third divided regions DR1, DR2, and DR3, respectively, of the display device 101 based on the state of the vehicle in which the display device 101 is installed, information to be displayed in each region in accordance with the state of the vehicle, and operations by drivers and passengers on AV devices, car navigation systems, and the like installed in the vehicle. Further, the display device 101 sequentially generates the determined contents and the first, second, and third images at the frame frequencies, and then inputs them to the control device 90. As described above, the control device 90 generates the start signals and the output polarity control signals based on the video synchronization signals of the first image, the second image, and the third image, and outputs these signals to the scanning line drive circuits 60 and the data line drive circuits 70 of the first divided region DR1, the second divided region DR2, and the third divided region DR3 together with the image signals of the first image, the second image, and the third image, respectively. As described above, the timing controller 92 of the control device 90 and the scanning line drive circuits 60 in each divided region are connected to each other by a respective one of the independent start signal wiring lines 21, 22, and 23 (FIG. 4A), and thus the control device 90 can independently output the start signal to the scanning line drive circuits 60 in each divided region. Thus, as shown in FIG. 19, images can be displayed at frame frequencies different from each other in the first divided region DR1, the second divided region DR2, and the third divided region DR3.

As shown in FIG. 19, when the frame frequency of the image is different in the same divided region or different divided regions, the interval of the start signal applied to the scanning line drive circuit 60 is different. However, as described above, by applying the scanning line clock signal in common to the scanning line drive circuit 60 in each divided region, the scanning periods can be made equal even when the images are displayed at different frame frequencies in different divided regions.

The difference in the frame frequency of the image is adjusted by the length of the pause period provided after the scanning period. Thus, in a period in which the scanning lines GL are scanned in one of the pair of divided regions adjacent to each other, the scanning of the scanning lines GL may be stopped in the other of the pair of divided regions adjacent to each other. For example, as shown in FIG. 19, when the first image is displayed at the frame frequency of 60 Hz in the first divided region DR1 and the second image is displayed at the frame frequency of 10 Hz in the second divided region DR2, there is a period in which scanning in the second divided region DR2 is stopped during the scanning period of the first divided region DR1.

As described in the first embodiment, in the pair of divided regions adjacent to each other among the first divided region DR1, the second divided region DR2, and the third divided region DR3, the scanning directions of the scanning line drive circuit 60 are opposite to each other. In addition, in the pair of divided regions adjacent to each other, the scanning directions of the plurality of scanning line connection wiring lines BL are also opposite to each other. On the other hand, in the first divided region DR1, the second divided region DR2, and the third divided region DR3, the scanning directions of the plurality of scanning lines GL are the same direction in the y-axis direction, and in the present embodiment, the plurality of scanning lines GL are scanned from top to bottom in any divided region.

### Third Embodiment

A driving method of the display device according to the present embodiment will be described. In the driving method according to the second embodiment, when the reverse driving is performed on the polarity of the data signal, the polarities are not adjusted between the divided regions. When the display device continues to display an image different for each divided region, it is not necessary to adjust the polarities of the data signals between the divided regions as in the driving method according to the second embodiment. However, when an image continuous over all of the pair of divided regions adjacent to each other or three or more divided regions is displayed, the reverse polarity between the divided regions is preferably adjusted. The present embodiment deals with such image display.

FIG. 21 shows a timing to scan the scanning lines GL in each divided region in the present embodiment. In FIG. 21, the video synchronization signal (V sync), the data signal (V Data), the start signal (SP), and the scanning timing chart (Panel Scan) are the same as those in the second embodiment. The timing controller 92 of the control device 90 generates the following signals to control the scanning line drive circuit 60 and the data line drive circuit 70.

As described in the second embodiment, the master clock signal (M Sync) is a pulse signal that matches the frame frequency of the image displayed at the fastest cycle among the images displayed in all the divided regions. The output of a write polarity flag signal (M Pol) is sequentially reversed from 0 to 1 or from 1 to 0 each time the master clock signal is received.

The timing controller 92 includes a video memory that temporarily stores an image signal generated from the video data signal and output to each divided region until receiving transfer of the video data signal of the next frame, that is, in a period in which transmission of the video data signal is stopped. “V Memory” in FIG. 21 indicates an image signal stored in the video memory, and “A”, “B”, “C”, and the others indicate image signals of consecutive frames.

A start pulse enable flag signal (SP Env) becomes 1 in synchronization with the video synchronization signal (V Sync), and is switched to 0 at the same time as fall of the start signal. The output of a panel polarity flag signal (P Pol) is reversed from 0 to 1 or from 1 to 0 each time the start signal is received. A panel polarity comparison flag signal (Pol Comp) compares the immediately preceding write polarity flag signal (M Pol) with the panel polarity flag signal (P Pol) in synchronization with the master clock signal (M Sync), and outputs 1 when the values match each other, and outputs 0 when the values do not match each other.

A start pulse signal (SP) is output in synchronization with the master clock signal (M Sync) when both the start pulse enable flag signal (SP Env) and the panel polarity comparison flag signal (Pol Comp) are 1. The scanning line drive circuit which has received the start pulse signal (SP) performs the scanning of the scanning lines as shown in the scanning timing chart (Panel Scan). At this time, in accordance with the value of the immediately preceding panel polarity flag signal (P Pol), the scanning line drive circuit outputs the data signal with a positive polarity when the value is 1 and with a negative polarity when the value is 0.

By performing such control, in each divided region, the start pulse enable flag signal (SP Env) is output, and the scanning of the scanning lines GL is started at the timing at which the polarity of the data signal to be written matches in the write polarity flag signal (M Pol) whose value is periodically reversed between 0 and 1.

For example, in FIG. 21, at the timing at which the video synchronization signal (V sync) of the image frame indicated by B is output, the write polarity flag signal (M Pol) is 0, and at this timing, writing of the data signal with the negative polarity is not allowed, so that the panel polarity comparison flag signal (Pol Comp) is not output. Thereafter, at the timing at which the write polarity flag signal (M Pol) becomes 1, the panel polarity comparison flag signal (Pol Comp) is output, and thus scanning of the image frame indicated by B with the positive polarity is started at this time.

As described above, the control device 90 sequentially generates the write polarity flag signal indicating a write polarity of the data signal output to the data line, and outputs the start signal to the start signal wiring line connected to the scanning line drive circuit in each divided region based on the write polarity flag signal. The write polarity flag signal (M Pol) is used in common to determine the timing to generate the start signal in each divided region, and thus the timing at which the scanning of scanning lines is started and the polarity of the data signal in each divided region follow the write polarity flag signal (M Pol).

Thus, according to the present embodiment, the frame frequency of the image to be displayed can be changed while correctly maintaining the reverse polarity driving of the data signal in each divided region. In addition, in the case in which the number of data lines in each divided region is an even number, even when the frame frequencies of the images to be displayed are changed at any timing in the pair of divided regions adjacent to each other, regularity of the reverse polarity of the data signals can be continued between the pair of divided regions. Thus, for example, even in the pair of pixel columns included in the first divided region DR1 and the second divided region DR2, respectively, with the boundary line BD12 interposed therebetween and in the pair of pixel columns included in the second divided region DR2 and the third divided region DR3, respectively, with the boundary line BD23 interposed therebetween, the polarities are not aligned, and the reverse driving is correctly performed. Thus, the liquid crystal layer is prevented from being deteriorated due to biased voltage applied to the liquid crystal in the vicinity of the boundary line. As a result, in particular, even in a case in which the image continuous over all of the pair of divided regions adjacent to each other or three or more divided regions is displayed, occurrence of display unevenness or the like along the column direction in the vicinity of the boundary line is suppressed, and uniform display can be performed.

FIG. 22 shows timings to scan the scanning lines GL in the three divided regions by the driving method of the display device according to the present embodiment. Similarly to FIG. 19, in FIG. 22, three signal groups for displaying images (the first image, the second image, and the third image) in the first divided region DR1, the second divided region DR2, and the third divided region DR3 are shown in an upper part, a central part, and a lower part, respectively. The master clock signal (M Sync) and the write polarity flag signal (M Pol) which are used in common for the first divided region DR1, the second divided region DR2, and the third divided region DR3 are shown in the uppermost part.

In the present embodiment, the highest frame frequency of the image to be displayed is 120 Hz, and the frequency of the master clock signal (M Sync) is also set to 120 Hz. The value of the write polarity flag signal (M Pol) is reversed each time the master clock signal (M Sync) is output, and thus the frequency of the write polarity flag signal (M Pol) is 60 Hz. That is, in the basic cycle of the write polarity flag signal (M Pol), the value is 1 in the first half period and the value is 0 in the second half period. For this reason, for the image at the frame frequency of 60 Hz, when the scanning lines are scanned at the frame frequency of 60 Hz while the polarity of the data signal is reversed, the polarity of the data signal does not match the value of the master clock signal (M Sync) every two cycles, so that the scanning is delayed by a period corresponding to 120 Hz.

As a result, as shown in FIG. 22, in any divided region, when the image is displayed at the frame frequency of 60 Hz, the scanning lines are continuously scanned at least twice in at least two continuous frame periods, and the scanning is paused in the subsequent period, that is, a remaining period obtained by subtracting the at least two scanning periods from the total of the at least two frame periods. As described above, even when the scanning period of the scanning lines GL continues, the polarity of the data signal is reversed, so that the bias of the polarity of the pixel application voltage which is a voltage applied to the liquid crystal layer is suppressed.

Note that in a case in which the frame frequency of the image to be displayed is low, it is conceivable that a pixel is not sufficiently charged due to a short scanning period and electric charge leaks due to a long pause period after the scan period, so that the image appears flickering. In this case, for example, as shown in FIG. 23, the scanning of the scanning lines may be continuously performed a plurality of times.

For example, when an image is displayed at 10 Hz in any one of the divided regions, the data line drive circuit 70 receives the image signal stored in the video memory, and continuously outputs the same signal a plurality of times while reversing the polarity of the same data signal in synchronization with the master clock signal. The scanning line drive circuit 60 receives the start signal a plurality of times from the timing controller 92 in synchronization with the master clock signal, that is, in synchronization with the output of the data signal, outputs the scanning signal each time the start signal is received, and scans the scanning lines GL. As a result, the scanning of the scanning lines is continuously performed a plurality of times, and then the scanning is paused. The scanning of the scanning lines may be continuously performed an even number of times or an odd number of times. When the number of times of the scanning is an odd number of times, the polarity of the pixel application voltage in a holding period is reversed for each pause period, and thus the bias of the polarity of the pixel application voltage can be suppressed.

By performing such driving, the pixel electrode can be appropriately charged even when one scanning time is short. In addition, deterioration of reliability of the switching element such as the TFT due to an increase in an off period of the switching element can be suppressed.

The driving method described with reference to FIG. 23 may be realized by the control device 90, or a video signal suitable for such a driving method may be prepared in advance and displayed on the display device 101. Specifically, as shown in FIG. 24, the video signal at the frame frequency of 10 Hz includes a plurality of continuous video data signals (V Data) and a plurality of continuous video synchronization signals (V Sync), which are synchronized with the master clock signal. As in the driving method shown in FIG. 23, the numbers of the plurality of continuous image signals and video synchronization signals (V Sync) are odd numbers, and more specifically, the video data signal (V Data) at the frame frequency of 10 Hz includes three continuous identical video data signals (V Data) and three continuous identical video synchronization signals (V Sync).

The control device 90 receives transmission of the video data signal (V Data) and the video synchronization signal (V Sync), generates the start signal (SP) in synchronization with the video synchronization signal (V Sync), and generates an image signal (not shown) based on the video data signal (V Data). The generated start signal and image signal are output to the scanning line drive circuit 60 and the data line drive circuit 70, respectively.

The data line drive circuit 70 receives the image signal and outputs the data signal to the data line SL. As shown in the lower part of FIG. 24, the data line drive circuit 70 continuously outputs the same data signal A three times while reversing the polarity, and then provides a pause period by not outputting the data signal. Subsequently, the data line drive circuit 70 continuously outputs the data signal B three times while reversing the polarity, and then provides a pause period in which the data signal is not output. In this way, the control device 90 receives the video data signal and then stops outputting the start signal in the period in which the transmission of the video data signal is stopped.

A video data transmission interval, which is a period from the timing to output the third data signal to the timing to output the data signal of the next frame, match a start signal output interval, which is a period from the timing to output the third start signal to the timing to output the start signal of the next frame.

By preparing such a video signal, the configuration of the control device 90 can be simplified and the cost of the entire display device 101 can be reduced. Further, when the video signal is prepared, by appropriately adjusting the timing of changes in the frame frequency, the reverse polarity between the divided regions can be adjusted as shown in the third embodiment.

The display device and the driving method according to the second and third embodiments are merely examples, and various modifications may be made. For example, the frame frequencies of the image displayed in each divided region are not limited to the combination of 10 Hz, 60 Hz, and 120 Hz, and may be other frequencies. The images may be displayed at four or more different frequencies. A control method for generating the start signal based on the write polarity flag signal is not limited to the above-described embodiment, and other control methods may be employed. Further, in the second and third embodiments, the polarity of the data signal output from the data line drive circuit is controlled by the output polarity control signal, but the data line drive circuit may automatically reverse the polarity each time the data signal is output.

The display device of the disclosure can be explained as follows.

A display device and a driving method of a display device according to a first configuration of the disclosure includes
a substrate including a main surface including a display region and a non-display region located around the display region, the display region including a plurality of divided regions divided into three or more and disposed adjacent to each other along a first direction,
a plurality of scanning lines disposed in each of the plurality of divided regions, extending in the first direction, and arrayed in a second direction intersecting the first direction,
a plurality of data lines disposed in each of the plurality of divided regions, the plurality of scanning lines extending in the second direction, and being arrayed in the first direction,
a plurality of pixels disposed in each of the plurality of divided regions, each of the plurality of pixels being disposed in a region surrounded by a pair of data lines of the plurality of data lines and a pair of scanning lines of the plurality of scanning lines,
a plurality of scanning line connection wiring lines disposed in each of the plurality of divided regions, the plurality of data lines extending in the second direction, and being arrayed in the first direction,
a plurality of data line drive circuits connected to the plurality of data lines, respectively, in each of the plurality of divided regions,
a plurality of scanning line drive circuits corresponding to each of the plurality of divided regions,
a control device, and
a plurality of start signal wiring lines independently connecting the plurality of scanning line drive circuits corresponding to each of the plurality of divided regions and the control device to each other, in which
the plurality of scanning line drive circuits and the plurality of data line drive circuits are arrayed in the first direction outside the display region,
each of the plurality of scanning line connection wiring lines electrically connects each of the scanning line drive circuits to one of the plurality of scanning lines, and
the control device independently outputs a start signal to each of the plurality of start signal wiring lines connected to the plurality of scanning line drive circuits in each of the plurality of divided regions, and the plurality of scanning line drive circuits and the plurality of data line drive circuits display images at frame frequencies different from each other in at least a pair of divided regions adjacent to each other among the plurality of divided regions.

According to the first configuration, since some of the display region can be driven at a different frame frequency, power consumption can be reduced. The scanning line drive circuit and the data line drive circuit are disposed to face each other, and thus the divided regions adjacent to each other can be disposed in contact with each other, and a break of the images displayed in the divided regions can be made not noticeable. In addition, the start signal wiring line is independently connected to the scanning line drive circuit corresponding to each divided region, and thus each divided region can be independently controlled.

The display device or the driving method of the display device according to a second configuration in the first configuration may further include at least one selected from the group consisting of a power source wiring line, a clock signal wiring line, and a common wiring line that connect the plurality of scanning line drive circuits of the pair of divided regions adjacent to each other. By disposing at least one of the power source wiring line, the clock signal wiring line, and the common wiring line between the drive circuits, the number of wiring lines from the control device can be reduced.

In the display device or the driving method of the display device according to a third configuration in the first configuration, intervals of the plurality of start signals applied to the plurality of scanning line drive circuits may be different from each other in the pair of divided regions adjacent to each other.

In the display device or the driving method of the display device according to a fourth configuration in the first configuration, a relationship of Nb×Tspa=Na×Tspb may be satisfied in the pair of divided regions adjacent to each other where Tspa is an interval of the start signal applied to each of the plurality of scanning line drive circuits in one region, Tspb is an interval of the start signal in the other region, and Na and Nb are any natural numbers. The clock frequency of the gate or the like can be unified, the on/off timing of the TFT can be made common in the panel, and the entire driving system can be simplified.

In the display device or the driving method of the display device according to a fifth configuration in the first configuration, scanning periods in which the plurality of scanning lines arranged in the second direction are scanned once may be equal to each other in the pair of divided regions adjacent to each other. By making the scanning periods equal, that is, by making the clock signal common, the on/off timing of the TFT can be made common in the panel while making the frame frequency different for each region, and the entire driving system can be simplified.

In the display device or the driving method of the display device according to a sixth configuration in the first configuration, in a period in which the plurality of scanning lines are scanned in one of the pair of divided regions adjacent to each other, scanning of the plurality of scanning lines may be stopped in the other of the pair of divided regions adjacent to each other. By stopping the scanning, power consumption can be reduced.

In the display device or the driving method of the display device according to a seventh configuration in the first configuration, the number of the plurality of data lines may be an even number in each of the plurality of divided regions. By setting the number of data lines in each divided region to an even number, even when a polarity of the data signal is reversed by a method such as column-reversal or dot-reversal when a continuous image, a moving picture, or the like is displayed in two or more adjacent regions regularity of a polarity determination at the boundary can be maintained. Even when the plurality of divided regions are made continuous as one display region and the image or the moving picture is displayed, a joint is not visually recognized.

In the display device or the driving method of the display device according to an eighth configuration in the first configuration, periods in which the polarities of the data signals are the same and periods in which the polarities of the data signals are different from each other may be repeated in one set of pixels belonging to the pair of divided regions adjacent to each other, respectively.

In the display device or the driving method of the display device according to a ninth configuration in the first configuration, the control device may control the plurality of data line drive circuits to output data signals of at least two continuous frames to the plurality of data lines with polarity reversed for each frame, continuously scan the plurality of scanning lines at least twice in the at least two continuous frame periods, and pause the scanning in a subsequent period in at least one of the plurality of divided regions. By reversing the polarities of the data signals of two continuous frames and continuously writing the data signals, the bias of the polarity of the data signals can be suppressed without using a source driver for automatically reversing the polarities or a signal for controlling the output polarity.

In the display device or the driving method of the display device according to a tenth configuration in the first configuration, the control device may sequentially generate a write polarity flag signal indicating a write polarity of a data signal output from the plurality of data line drive circuits to the plurality of data lines in the plurality of more divided regions, and output the start signal to the start signal wiring line connected to the scanning line drive circuit in each divided region based on the write polarity flag signal. By outputting the start signal to the scanning line drive circuit in each divided region in synchronization with the flag signal, the reverse polarity of the data signal can be controlled over the divided regions.

In the display device or the driving method of the display device according to an eleventh configuration in the first configuration, scanning directions of the plurality of scanning line drive circuits may be opposite to each other in the pair of divided regions adjacent to each other.

In the display device or the driving method of the display device according to a twelfth configuration in the first configuration, scanning directions of the plurality of scanning line connection wiring lines may be opposite to each other in the pair of divided regions adjacent to each other.

In the display device or the driving method of the display device according to a thirteenth configuration in the twelfth configuration, the plurality of scanning lines may be scanned in the same direction in the second direction.

In the display device or the driving method of the display device according to a fourteenth configuration in the first configuration, the control device may externally receive video data signals corresponding to images displayed in the plurality of divided regions, respectively, and the control device may stop outputting the start signal in a period in which transmission of the video data signal is stopped in at least one of the plurality of divided regions.

In the display device or the driving method of the display device according to a fifteenth configuration in the first configuration, the control device may externally receive video data signals corresponding to images displayed in the plurality of divided regions, respectively, and generate image signals output to the plurality of data line drive circuits based on the video data signals, the control device may include a video memory that temporarily holds the generated image signals, and the image signal output to the data line drive circuit of the at least one region may be held in the video memory in a period in which transmission of the video data signal corresponding to the display image of the divided region is stopped in at least one of the plurality of divided regions.

In the display device or the driving method of the display device according to a sixteenth configuration in the first configuration, the control device may externally receive video data signals corresponding to images displayed in the plurality of divided regions, respectively, and an interval of the start signal output to the scanning line drive circuit may match an interval of transmission of the video data signal in at least one of the three or more divided regions.

In the display device or the driving method of the display device according to a seventeenth configuration in the first configuration, each of the plurality of data line drive circuits may continuously output the same data signal a plurality of times, and then pause outputting the data signal in at least one of the plurality of divided regions. The circuit of the display device can be simplified and the cost can be suppressed as a whole.

In the display device or the driving method of the display device according to an eighteenth configuration in the seventeenth configuration, the plurality of times may be an odd number.

In the display device or the driving method of the display device according to a nineteenth configuration in the fifteenth configuration, the data line drive circuit may receive the image signals stored in the video memory and continuously output the same data signal a plurality of times while reversing the polarity of the same data signal, and the scanning line drive circuit may continuously output the scanning signal a plurality of times in synchronization with the output of the data signal to scan the plurality of scanning lines and then pause the scanning in at least one of the three or more divided regions. As a result, the charging rate of the panel can be increased, the flickering of the screen can be suppressed, the bias of the gate voltage can be suppressed, and the reliability can be improved.

In the display device or the driving method of the display device according to a twentieth configuration in the nineteenth configuration, the number of the plurality of frames may be an odd number.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A display device comprising:
a substrate including a main surface including a display region and a non-display region located around the display region, the display region including a plurality of divided regions divided into three or more and disposed adjacent to each other along a first direction;
a plurality of scanning lines disposed in each of the plurality of divided regions, the plurality of scanning lines extending in the first direction, and being arrayed in a second direction intersecting the first direction;
a plurality of data lines disposed in each of the plurality of divided regions, the plurality of data lines extending in the second direction, and being arrayed in the first direction;
a plurality of pixels disposed in each of the plurality of divided regions, each of the plurality of pixels being disposed in a region surrounded by a pair of data lines of the plurality of data lines and a pair of scanning lines of the plurality of scanning lines,
a plurality of scanning line connection wiring lines disposed in each of the plurality of divided regions, the plurality of scanning line connection wiring lines extending in the second direction, and being arrayed in the first direction;
a plurality of data line drive circuits connected to the plurality of data lines, respectively, in each of the plurality of divided regions;
a plurality of scanning line drive circuits corresponding to each of the plurality of divided regions;
a control device; and
a plurality of start signal wiring lines independently connecting the plurality of scanning line drive circuits corresponding to each of the plurality of divided regions and the control device to each other,
wherein the plurality of scanning line drive circuits and the plurality of data line drive circuits are arrayed in the first direction outside the display region,
each of the plurality of scanning line connection wiring lines electrically connects each of the plurality of scanning line drive circuits to one of the plurality of scanning lines, and
the control device independently outputs a start signal to each of the plurality of start signal wiring lines connected to the plurality of scanning line drive circuits in each of the plurality of divided regions, and thus the plurality of scanning line drive circuits and the plurality of data line drive circuits display images at frame frequencies different from each other in at least a pair of divided regions adjacent to each other among the plurality of divided regions.

2. The display device according to claim 1, further comprising:
at least one selected from the group consisting of a power source wiring line, a clock signal wiring line, and a common wiring line, configured to connect the plurality of scanning line drive circuits of the pair of divided regions adjacent to each other.

3. The display device according to claim 1,
wherein intervals of the plurality of start signals applied to the plurality of scanning line drive circuits are different from each other in the pair of divided regions adjacent to each other.

4. The display device according to claim 1,
wherein a relationship of Nb×Tspa=Na×Tspb is satisfied in the pair of divided regions adjacent to each other, where Tspa is an interval of the start signal applied to each of the plurality of scanning line drive circuits in one region, Tspb is an interval of the start signal in the other region, and Na and Nb are any natural numbers.

5. The display device according to claim 1,
wherein scanning periods in which the plurality of scanning lines arranged in the second direction are scanned once are equal to each other in the pair of divided regions adjacent to each other.

6. The display device according to claim 1,
wherein in a period in which the plurality of scanning lines are scanned in one of the pair of divided regions adjacent to each other, scanning of the plurality of scanning lines is stopped in the other of the pair of divided regions adjacent to each other.

7. The display device according to claim 1,
wherein the number of the plurality of data lines is an even number in each of the plurality of divided regions.

8. The display device according to claim 1,
wherein the control device controls the plurality of data line drive circuits to output data signals of at least two continuous frames to the plurality of data lines with a polarity reversed for each frame, continuously scans the plurality of scanning lines at least twice in the at least two continuous frame periods, and pauses the scanning in a subsequent period in at least one of the plurality of divided regions.

9. The display device according to claim 1,
wherein scanning directions of the plurality of scanning line drive circuits are opposite to each other in the pair of divided regions adjacent to each other.

10. The display device according to claim 9,
wherein the scanning directions of the plurality of scanning line connection wiring lines are opposite to each other in the pair of divided regions adjacent to each other.

11. The display device according to claim 1,
wherein the control device externally receive video data signals corresponding to images displayed in the plurality of divided regions, respectively, and
the control device stops outputting the start signal in a period in which transmission of the video data signal is stopped in at least one of the plurality of divided regions.

12. The display device according to claim 1,
wherein each of the plurality of data line drive circuits continuously outputs the same data signal a plurality of times, and then pauses outputting the data signal in at least one of the plurality of divided regions.

13. The display device according to claim 12,
wherein the plurality of times is an odd number.

14. A control method of a display device including a display panel and control device,
wherein the display panel includes
a substrate including a main surface including a display region and a non-display region located around the display region, the display region including a plurality of divided regions divided into three or more and disposed adjacent to each other along a first direction,
a plurality of scanning lines disposed in each of the plurality of divided regions, the plurality of scanning lines extending in the first direction, and being arrayed in a second direction intersecting the first direction,
a plurality of data lines disposed in each of the plurality of divided regions, the plurality of data lines extending in the second direction, and being arrayed in the first direction,
a plurality of pixels disposed in each of the plurality of divided regions, each of the plurality of pixels being disposed in a region surrounded by a pair of data lines of the plurality of data lines and a pair of scanning lines of the plurality of scanning lines,
a plurality of scanning line connection wiring lines disposed in each of the plurality of divided regions, the plurality of scanning line connection wiring lines extending in the second direction, and being arrayed in the first direction,
a plurality of data line drive circuits connected to the plurality of data lines, respectively, in each of the plurality of divided regions,
a plurality of scanning line drive circuits corresponding to each of the plurality of divided regions,
a control device, and
a plurality of start signal wiring lines independently connecting the plurality of scanning line drive circuits corresponding to each of the plurality of divided regions and the control device to each other,
the plurality of scanning line drive circuits and the plurality of data line drive circuits are arrayed in the first direction outside the display region,
each of the scanning line connection wiring lines electrically connects each of the plurality of scanning line drive circuits to one of the plurality of scanning lines, and
the control device independently outputs a start signal to each of the plurality of start signal wiring lines connected to the plurality of scanning line drive circuits in each of the plurality of divided regions, and thus the plurality of scanning line drive circuits and the plurality of data line drive circuits display images at frame frequencies different from each other in at least a pair of divided regions adjacent to each other among the plurality of divided regions.

15. The control method of the display device according to claim 14,
wherein the control device outputs the plurality of start signals at intervals different from each other in the pair of divided regions adjacent to each other.

16. The control method of the display device according to claim 15,
wherein a relationship of Nb×Tspa=Na×Tspb is satisfied in the pair of divided regions adjacent to each other, where Tspa is an interval of the start signal applied to each of the plurality of scanning line drive circuits in one region, Tspb is an interval of the start signal in the other region, and Na and Nb are any natural numbers.

17. The control method of the display device according to claim 14,
wherein scanning periods in which the plurality of scanning line drive circuits once scan the plurality of scanning lines arranged in the second direction are equal to each other in the pair of divided regions adjacent to each other.

18. The control method of the display device according to claim 14,
wherein in a period in which the plurality of scanning line drive circuits scan the plurality of scanning lines in one of the pair of divided regions adjacent to each other, the plurality of scanning line drive circuits stop scanning of the plurality of scanning lines in the other of the pair of divided regions adjacent to each other.

19. The control method of the display device according to claim 18,
wherein the plurality of scanning line drive circuits in the pair of divided regions adjacent to each other reverse a polarity of a data signal and output the data signal in a manner that a period in which polarities of a plurality of the data signals are the same and a period in which the polarities of the plurality of data signals are different from each other are repeated in a set of pixels belonging to the pair of divided regions adjacent to each other, respectively.

20. The control method of the display device according to claim 14,
wherein the control device controls the plurality of data line drive circuits to output data signals of at least two continuous frames to the plurality of data lines with polarity reversed for each frame, continuously scans the plurality of scanning lines at least twice in the at least two continuous frame periods, and pauses the scanning in a subsequent period in at least one of the plurality of divided regions.
